(19) United States
(12) Patent Application Publication
(10) Pub. No.: US 2004/0183761 A1
(43) Pub. Date: Sep. 23, 2004

(54) Method and device for driving display device, and program and recording medium therefor

(76) Inventors: Koichi Miyachi, Soraku-gun (JP); Hidekazu Miyata, Nagoya-shi (JP); Akihito Jinda, Kitakatsuragi-gun (JP); Kazunari Tomizawa, Soraku-gun (JP); Makoto Shiomi, Tenri-shi (JP)

Correspondence Address: HARNESS, DICKEY & PIERCE, P.L.C., P.O. BOX 8910, RESTON, VA, 20195, US

(21) Appl. No.: 10/742,933

(22) Filed: Dec. 23, 2003

(30) Foreign Application Priority Data
Dec. 27, 2002 (JP) 2002-381618

(51) Int. Cl. G09G 3/36

(52) U.S. Cl. 345/87

(57) ABSTRACT

A line memory interpolates interlace video signals between horizontal lines to generate current-field video signals of one frame. A field memory stores the current-field video signals until input of the next field, and interpolates video signals between horizontal lines in the previous field to generate previous-field video signals of one frame. In the current-field video signals and previous-field video signals, an arithmetic circuit refers to video signals corresponding to the same pixels, so as to generate correction video signals for these pixels. By thus driving a group of pixels of one frame on a field basis, luminance can be increased. Further, by modulating the driving signals based on video signals of the previous field, a response speed of the pixels can be increased. Despite these advantages, modulation error will not be caused by mispairing of calculated video signals, thereby providing a display device with good display quality.

This Nonprovisional application claims priority under 35 U.S.C. § 119(a) on Patent Application No. 2002/381618 filed in Japan on Dec. 27, 2002, the entire contents of which are hereby incorporated by reference.

### FIELD OF THE INVENTION

The present invention relates to a method and device for driving display devices, and to a program and recording medium therefor.

### BACKGROUND OF THE INVENTION

Liquid crystal display devices operate at relatively low operating power, and have been pervasive not only in portable devices but also in devices of a stationary type. The liquid crystal display device has a slower response speed than other types of display devices including the CRT (Cathode Ray Tube), and, depending on a grayscale level, may fail to respond within a rewrite time (16.7 msec) which corresponds to a normal frame frequency of 60 Hz. The issue is addressed in, for example, U.S. Published Patent Application No. 2002/0044115, which discloses driving a liquid crystal display device with a driving signal modulated for facilitating a transition from a current to a desired grayscale level.

Specifically, as illustrated in FIG. 19, one of frame memories 102 through 104 in a display device 101 receives incoming video data of the current frame, and stores the video data until the next frame. The video data of the current frame is carried on a video signal and supplied to an arithmetic circuit 105 from the frame memories 102 through 104. Here, the arithmetic circuit 105 also receives a video signal carrying data of the previous frame. The video signals of the previous and current frames are used for correction by the arithmetic circuit 105 to facilitate a grayscale level transition from the previous to current frame. The arithmetic circuit 105 then outputs a correction video signal to a liquid crystal display panel 106. Based on the correction video signal, the liquid crystal display panel 106 drives the pixels.

For example, when a grayscale level transition from a previous frame FR(k−1) to a current frame FR(k) is a “rise,” a grayscale level transition from the previous to current frame is facilitated by varying the level of applied voltage to a pixel. Specifically, a voltage is applied that is greater than the voltage level represented by video data D(i, j, k) for the current frame FR(k).

As a result, in the grayscale level transition, the luminance level of the pixel increases at a faster rate and more quickly reaches an approximate luminance level represented by the video data D(i, j, k) for the current frame FR(k), as compared with the luminance level attained by directly applying the voltage level represented by the video data D(i, j, k) for the current frame FR(k). In this way, a response speed of the liquid crystal display panel is increased despite the use of the slow-responding liquid crystal.

Here, unlike the CRT, the liquid crystal display panel is not self-emitting, and uses a light source such as a backlight to set a luminance for respective pixels by varying the quantity of emitted light from the light source. Thus, the light source consumes power even during dark display.

For this characteristic of the liquid crystal display panel, the liquid crystal display panel commonly employs a driving method in which all pixels are driven with the video signal of the current field when driving pixels according to an interlace signal.

Specifically, as illustrated in FIG. 20, upon receiving an interlace signal, a data signal line driving circuit of the liquid crystal display panel samples video data of each horizontal line in the current field.

Based on the result of sampling for each horizontal line, the data signal line driving circuit drives pixels of two horizontal lines. The same data is thus applied to two horizontal lines, enabling the liquid crystal display panel to drive all pixels based on the video signal of the current field, despite the fact it has received the interlace signal. This is more advantageous in improving luminance of the display device than having dark display for the pixels other than those corresponding to the current field.

### SUMMARY OF THE INVENTION

However, when the liquid crystal display panel shown in FIG. 19 is operated at the timings of FIG. 20 to cause the arithmetic circuit to generate a correction video signal for facilitating a grayscale level transition from the previous to current field, a modulation error may occur due to mispairing of video signals when facilitating a grayscale level transition, with the result that display quality of the display device deteriorates.

Specifically, upon receiving the interlace signal, the arithmetic circuit 105 shown in FIG. 19 carries out calculations for an Nth horizontal line of the previous field and for an Nth horizontal line of the current field, as illustrated in FIG. 21, so as to generate a video signal (correction video signal) for facilitating a grayscale level transition from the previous to current field. The correction video signal is sampled as in FIG. 20 by the data signal line driving circuit of the liquid crystal panel 106a shown in FIG. 19, so that the result of sampling for one horizontal line is outputted twice.

It should be noted however that horizontal lines occupy different positions between the previous field and current field. For example, as illustrated in FIG. 22, an Nth horizontal line (2nd line, for example) in odd-numbered fields corresponds to a (2N−1)th line (3rd line) of the frame, whereas an Nth horizontal line in even-numbered fields corresponds to an (2N)th line (4th line) of the frame.

Thus, when the data signal line driving circuit of the liquid crystal display panel 106a outputs the video signal of one horizontal line twice, the same data is produced for the first and second horizontal lines of the frame in odd-numbered fields, and for the second and third horizontal lines of the frame in even-numbered fields, as shown in FIG. 23.

It should be reminded here that the arithmetic circuit 105 carries out calculations for the Nth horizontal line of the previous field and for the Nth horizontal line of the current field as shown in FIG. 22, so as to generate a correction video signal for the Nth horizontal line of the current field.

Thus, as shown in FIG. 24, the correction video signal for driving, for example, the second line of the frame is generated by the calculations of the data in the first lines of the previous and current fields in both of odd-numbered and even-numbered fields. However, the correction video signal for driving the pixels in the third line of the frame is based on the calculations of the data in the second lines of the previous and current fields in odd-numbered fields, whereas it is based on the calculations of the data in the first lines of the previous and current fields in even-numbered fields. Note that, in FIG. 24, data containing the same information are surrounded by bold lines.

Hence, while the arithmetic circuit 105 may be able to refer to a proper video signal for the second line of the frame to properly facilitate a grayscale level transition, it refers to a wrong video signal for the third line of the frame, failing to properly carry out a grayscale level transition. This may cause error in facilitating a grayscale level transition for the pixels, with the result that an unintended grayscale level is displayed.

An object of the present invention is to provide a display device having good display quality. The object is attained by preventing modulation error caused by mispairing of calculated data despite that a plurality of pixels of one frame are driven to increase luminance, and that driving signals are modulated by referring to video signals of the previous field for a faster response speed of the pixels.

In order to achieve this object, the present invention provides a method for driving a group of pixels in a display device to display an image of a respective frame based on an interlace signal for displaying an image of a respective frame from video signals of a plurality of fields, the method including the steps of: (I) generating driving signals based on video signals of a current field, so as to drive the group of pixels for displaying the frame image; (II) modulating the driving signals for driving the group of pixels, by referring to video signals of a previous field; (III) interpolating video signals for the previous field before modulating the driving signals, so as to generate video signals of one frame; and (IV) interpolating video signals for the current field before modulating the driving signals, so as to generate video signals of one frame, in the step (II), the driving signals being respectively modulated for the group of pixels by referring to video signals of the previous field used to generate the driving signals for the respective pixels.

The method refers to video signals of the previous field, but a group of pixels for displaying an image of one frame are basically driven based on video signals of the current field. Thus, with this method, the display device can have improved luminance, compared with turning OFF pixels corresponding to video signals of the other fields. Further, the method refers to video signals of the previous field to modulate driving signals for the current field. This increases a response speed of the pixels, compared with driving a group of pixels based solely on the video signals of the current field.

Further, the method interpolates video signals of the previous field and current field before the modulation step, so as to generate video signals of one frame for the previous field and the current field. In the modulation step, the driving signals are respectively modulated for the pixels by referring to video signals of the previous field used to generate the driving signals for the respective pixels.

By thus driving a group of pixels of one frame on a field basis, luminance can be increased. Further, by modulating the driving signals based on video signals of the previous field, a response speed of the pixels can be increased. Despite these advantages, modulation error will not be caused by mispairing of video signals, thereby providing a display device with good display quality.

Further, by modulating the driving signals based on the video signals of the previous field, a response speed of the pixels can be increased by the modulation. In addition, less memory space is required for the modulation, as compared with modulating the driving signals by referring to the video signals of the previous frame.

In order to achieve the foregoing object, the present invention provides a driving device for a display device, the driving device including: a current-and-previous field video signal generating section for generating video signals for a current field and video signals for a previous field based on an interlace signal for displaying an image of a respective frame from video signals of a plurality of fields; and a driving signal generating section for generating driving signals for driving the group of pixels to display the frame image, the driving signals being generated according to the video signals of the current field and being modulated according to the video signals of the previous field, the current-and-previous field video signal generating section including: a previous-field interpolating section for interpolating respective lines of the previous field so as to generate video signals of one frame for the previous field; and a current-field interpolating section for interpolating respective lines of the current field so as to generate video signals of one frame for the current field, and the driving signal generating section respectively generating the driving signals for the group of pixels, so that the driving signals of the respective pixels are modulated by referring to the video signals of the previous field used to generate the driving signals of the respective pixels.

With this structure, the driving signal generating section generates driving signals according to the outputs of the previous-field interpolating section and the current-field interpolating section. This enables the driving device for a display device to drive a group of pixels for the display device using the foregoing driving method for a display device.

Thus, as with the driving method for a display device, despite the fact that a group of pixels of one frame are driven to increase luminance, and that driving signals are modulated by referring to the video signals of the previous field to increase the response speed of the pixels, modulation error caused by mispairing of compared video signals does not occur. As a result, display quality of the display device can be improved.

Further, with the foregoing structure, modulation is carried out by referring to the video signals of the previous field. Thus, in addition to increasing the response speed of the pixels by modulation, less memory space is required for the modulation, as compared with carrying out modulation by referring to the video signals of the previous frame.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a block diagram showing a main structure of a modulation-driving processing section of an image display device in one embodiment of the present invention.

FIG. 2 is a block diagram showing a main structure of the image display device.

FIG. 3 is a circuit diagram showing an exemplary structure of a pixel in the image display device.

FIG. 4 is a flowchart representing an operation of the image display device.

FIG. 5 is a timing chart representing an operation of the image display device.

FIG. 6 is a block diagram showing an exemplary structure of a line memory provided in the modulation-driving processing section.

FIG. 7 is a block diagram showing a main structure of a modulation-driving processing section in another embodiment of the present invention.

FIG. 8 is a view illustrating how flicker is caused.

FIG. 9 is a block diagram showing a main structure of a modulation-driving processing section in yet another embodiment of the present invention.

FIG. 10 is a graph representing a relationship between difference in video data and strength of modulation, explaining how the strength of modulation is changed by the modulation-driving processing section.

FIG. 11 is a graph representing a relationship between difference in video data and strength of modulation, explaining another way of changing the strength of modulation.

FIG. 12 is a block diagram showing an exemplary structure of the modulation-driving section.

FIG. 13 is a block diagram showing an exemplary structure of a line memory provided in the modulation-driving processing section.

FIG. 14 is a timing chart representing an operation of the modulation-driving processing section.

FIG. 15 is a block diagram showing another exemplary structure of the modulation-driving processing section.

FIG. 16 is a timing chart representing an operation of the modulation-driving processing section.

FIG. 17 is a timing chart representing an operation of the modulation-driving processing section, showing another exemplary structure of the modulation-driving processing section.

FIG. 18 is a view showing how a response speed varies in two-way response.

FIG. 19 is a block diagram illustrating a main structure of a conventional display device.

FIG. 20 is a timing chart representing an operation of a conventional liquid crystal display panel.

FIG. 21 is a timing chart representing how the display device of FIG. 19 operates according to the timing chart of FIG. 20.

FIG. 22 is a view representing interlace display of the CRT.

FIG. 23 is a view representing interlace display of a liquid crystal display device.

FIG. 24 is a view explaining mispairing of calculated data when the display device of FIG. 19 operates according to the timing chart of FIG. 20.

### DESCRIPTION OF THE EMBODIMENTS

[First Embodiment]

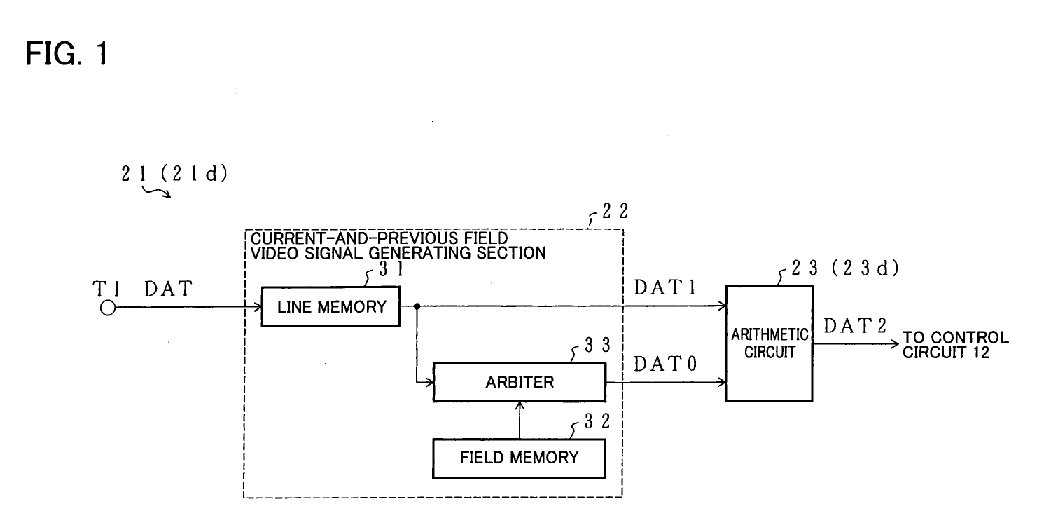

A First Embodiment of the present invention is described below with reference to FIG. 1 through FIG. 6. An image display device (display device) 1 of the present embodiment increases luminance of pixels by driving the pixels of one frame on a field basis. In addition, the image display device 1 modulates a driving signal by referring to video signals of the previous field. Despite these operations, the image display device 1 is able to prevent modulation error caused by mispairing of calculated data.

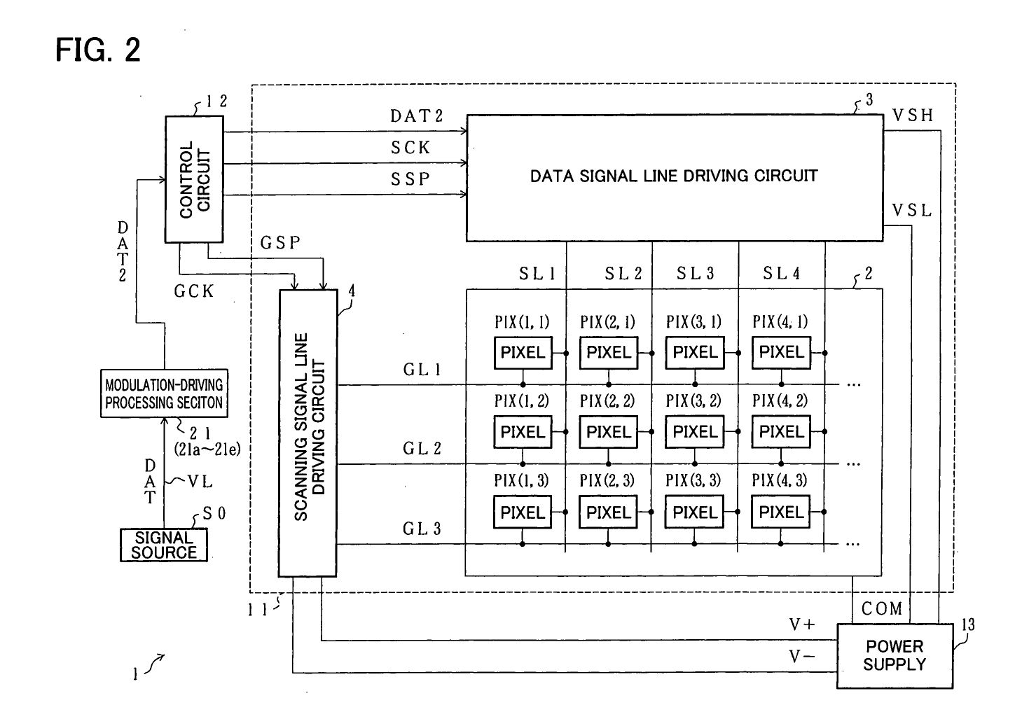

The image display device 1 includes a panel 11 that is provided with, as illustrated in FIG. 2, a pixel array 2 having pixels PIX (1, 1)-PIX (n, m) disposed in a matrix, a data signal line driving circuit 3 for driving data signal lines SL1-SLn of the pixel array 2, and a scanning signal line driving circuit 4 for driving scanning signal lines GL1-GLm of the pixel array 2. The image display device 1 further includes a control circuit 12 for supplying control signals to the data signal line driving circuit 3 and the scanning signal line driving circuit 4. The image display device 1 also includes a modulation-driving processing section 21 for modulating video signals supplied to the control section 12, so as to facilitate a grayscale level transition based on input video signals. All of these members operate on supplied power from a power supply 13.

Before describing a structure of the modulation-driving processing section 21 in detail, brief description is made first as to an overall structure and operation of the image display device 1. For convenience of explanation, alphabetic or numeric characters are used to identify positions of respective members, where necessary. For example, an ith data signal line SL is identified as data signal line SLi. Alphabetic or numeric characters are not appended when positions are not identified or when respective members are collectively referred to.

The pixel array 2 includes a plurality of data signal lines SL1-SLn (n data signal lines in this embodiment) and a plurality of scanning signal lines GL1-GLm (m scanning signal lines in this embodiment), crossing each other. At the intersection of a data signal line SLi and a scanning signal line GLj, a pixel PIX (i, j) is provided, where i is any integer from 1 to n, and j is any integer from 1 to m.

In the present embodiment, each pixel PIX (i, j) is surrounded by two adjacent data signal lines SL(i-1) and SLi and two adjacent scanning signal lines GL(j-1) and GLj.

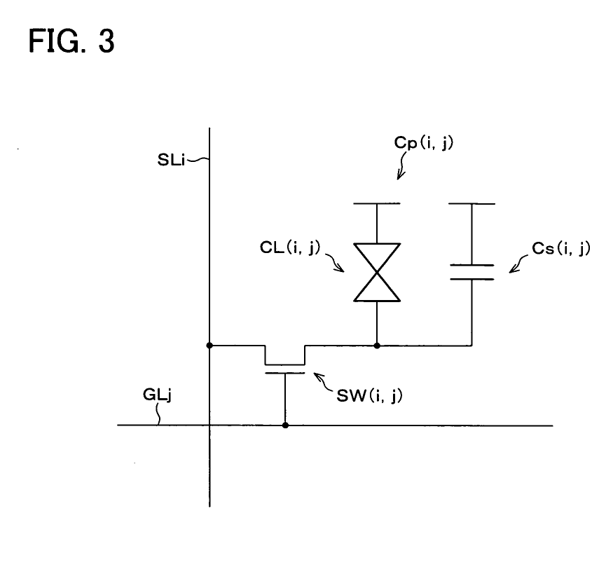

When the image display device 1 is a liquid crystal display device for example, a pixel PIX(i, j) includes, as shown in FIG. 3 for example, a field effect transistor SW(i, j) (switching element) and a pixel capacitor Cp(i, j), wherein the field effect transistor SW(i, j) has a gate and drain connected to a scanning signal line GLj and data signal line SLi, respectively, and the pixel capacitor Cp(i, j) has a terminal connected to the source of the field effect transistor SW(i, j). The other terminal of the pixel capacitor Cp(i, j) is connected to a common electrode line for all pixels PIX (i, j). The pixel capacitor Cp(i, j) includes a liquid crystal capacitor CL(i, j), and an auxiliary capacitor Cs(i, j), which is optionally provided.

In the pixel PIX(i, j), selecting the scanning signal line GLj turns ON the field effect transistor SW(i, j), causing an applied voltage to the data signal line SLi to be applied to the pixel capacitor Cp(i, j). When the scanning signal line GLi is deselected and the field effect transistor SW(i, j) is turned OFF, the voltage stored in the pixel capacitor Cp(i, j) is retained for the OFF period of the field effect transistor SW(i, j). Since the transmittance or reflectance of the liquid crystal varies according to the applied voltage to the liquid crystal capacitor CL(i, j), the display state of the pixel PIX(i, j) can be changed by applying a voltage to the data signal line SLi according to video data D while the scanning signal line GLi is being selected.

The liquid crystal display device according to the present embodiment employs a liquid crystal cell of a vertically aligned mode in which the liquid crystal molecules, which are aligned substantially vertical to the substrates under no applied voltage, are tilted in response to an applied voltage to the liquid crystal capacitor CL(i, j) of the pixel PIX(i, j). The liquid crystal cell is used in a normally-black mode (dark display under no applied voltage).

According to this structure, the scanning signal line driving circuit 4 shown in FIG. 2 feeds the scanning signal lines GL1-GLm with a signal indicative of a select period, such as a voltage signal, for example. According to a timing signal such as a clock signal GCK or a start pulse signal GSP supplied from the control circuit 12, the scanning signal line driving circuit 4 selects the scanning signal line GLj to which the select period signal should be supplied. The scanning signal lines GL1-GLm are thus sequentially selected at predetermined timings.

The data signal line driving circuit 3 samples a time division video signal DAT at predetermined timings for video data D for the pixels PIX. The data signal line driving circuit 3 outputs signals to the data signal lines SL1-SLn in accordance with the video data D. The data signal lines SL1-SLn then pass on the signals to the pixels PIX(1,j) to PIX(n,j) which are being selected through the scan signal line GLj by the scan signal line drive circuit 4.

The data signal line driving circuit 3 determines sampling timings and output timings of the output signals according to timing signals such as the clock signal SCK and start pulse signal SSP.

The brightness of the pixels PIX(1, j)-PIX(n, j) is determined by adjusting the luminance or transmittance of emitted light according to the output signals supplied to the data signal lines SL1-SLn while the corresponding scanning signal line GLj is being selected.

With the scanning signal lines GL1-GLm sequentially selected by the scanning signal line driving circuit 4, the pixels PIX(1,1)-PIX(n,m) of the pixel array 2 are set to the brightness indicated by the respective video data D, allowing for an update of the image displayed by the pixel array 2.

In the image display device 1 of the present embodiment, images are formed according to the video signal DAT, which is an interlace signal. The video signal DAT is supplied from a video signal source S0 to the modulation-driving processing section 21, and is transferred field by field, by dividing a frame into a plurality of fields (for example, two fields).

Specifically, to transfer the video signal DAT through a video signal line VL to the modulation-driving processing section 21 in the image display device 1, the video signal source S0 transfers all of video data for a field F(k) before transferring video data for a next field F(k+1). Video data is thus transferred by time division with respect to each field.

A field is made up of horizontal lines. For example, for a field F(k), all of the video data D(1, j, k)-D(n, j, k) for a horizontal line L(j) are transferred through the video signal line VL before the video data D(1, j+2, k)-D(n, j+2, k) for the next horizontal line (for example, L(j+2)) are transferred. Video data is thus transferred by time division with respect to each horizontal line. Note that, in the following, video data for a horizontal line L(j) are indicated by D(*, j, k).

In the present embodiment, each frame is made up of two fields. In an even-numbered field, video data is transferred for even-numbered horizontal lines forming the frame. In an odd-numbered field, video data is transferred for odd-numbered horizontal lines.

The video signal source S0 sends out the video data D(*, j, k) of each horizontal line, so that the video data D(*, j, k) are transferred through the video signal line VL by time division in a predetermined sequence.

In the present embodiment, the image display device 1 drives all the pixels PIX of the pixel array 2 based on video data of the current field, despite the fact that the video signal DAT from the video signal source S0 is an interlace signal. Further, in the process of generating a driving signal for each pixel PIX based on video data of the current field, the modulation-driving processing section 21 in the image display device 1 modulates the driving signal by referring to the video data of the previous field, so as to facilitate a grayscale level transition from the previous to current field.

More specifically, the modulation-driving processing section 21 of the present embodiment includes a current-and-previous video signal generating section 22 and an arithmetic circuit 23, as shown in FIG. 1. The current-and-previous video signal generating section 22 outputs a current field video signal DAT1 for the video data of the current field based on the interlace video signal. Further, the current-and-previous video signal generating section 22 stores the video data of the current field until the next field, and outputs a previous field video signal DAT0 of the previous field based on the video data so stored. The arithmetic circuit 23 modulates the video signal of the current field based on the previous field video signal DAT0 and the current field video signal DAT1, so as to generate and output a signal (correction video signal DAT2) for facilitating a grayscale level transition from the previous to current field.

With this arrangement, all pixels PIX are driven on a field basis, so that the overall luminance of the image display device 1 can be improved, as compared with carrying out dark display for the pixels PIX of the field other than the current field. Note that, when the image display device 1 is a liquid crystal display device with a light source (backlight, for example), the light source is ON during dark display. The dark display is obtained as the pixels PIX prevent the light of the light source from reaching the observer. Thus, power consumption is substantially the same for the dark display as for the bright display. Driving all pixels PIX on a field basis is therefore highly advantageous in improving overall luminance of the image display device 1 without greatly increasing power consumption.

Further, with the foregoing arrangement, since a grayscale level transition from the previous to current field is facilitated, the response speed of the image display device 1 can be increased even with relatively slow-responding pixels PIX. Further, despite the fact that the video data of the previous field are referred to, all pixels PIX of the pixel array 2 are basically driven based on the video data of the current field. Thus, even though a grayscale level transition is facilitated to increase the response speed, the amount of video data stored in the image display device 1 can be reduced, and the image display device 1 can be realized with a relatively small circuit scale, as compared with modulating the driving signal of the current field referring to the video data of the previous frame.

The modulation-driving processing section 21 of the present embodiment increases response speed and reduces circuit scale at the same time by modulating the video data of the current field according to the video data of the previous field. Despite this, modulation error caused by mispairing of compared fields is prevented because the video data of the previous and current fields are interpolated not in a subsequent stage of the arithmetic circuit 23 but in a preceding circuit (current-and-previous field video signal generating section 22, for example).

Specifically, the current-and-previous field video signal generating section 22 of the present embodiment includes a line memory 31, a field memory 32, and an arbiter 33. The line memory 31 stores incoming video data (interlace video signal DAT) of one horizontal line, and outputs the stored video data of one horizontal line twice by doubling the frequency. The field memory 32 stores the video data of the current field until the next field. The arbiter 33 writes video data of the current field in the field memory 32 based on the output of the line memory 31, and twice reads the stored data of one horizontal line in the field memory 32 before outputting it twice at the frequency of the line memory 31. The outputs of the line memory 31 and the arbiter 33 are supplied to the arithmetic circuit 23 as field video signals DAT1 and DAT0, respectively.

The arithmetic circuit 23 generates the correction video signal DAT2 based on the field video signals DAT0 and DAT1. The correction video signal DAT2 is generated as correction video data D2(i, j, k) based on video data (i, j, k−1) and D(i, j, k) corresponding to the same pixel PIX(i, j). The video data so corrected is supplied to the pixel PIX(i, j).

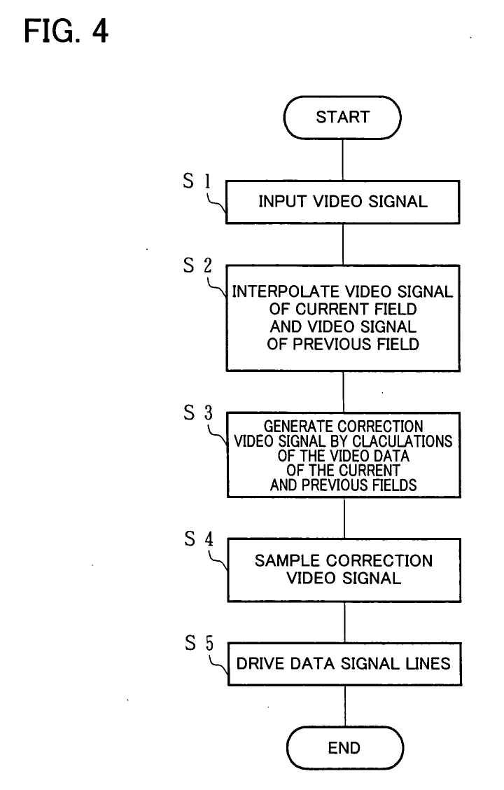

Referring to FIG. 4, the video signal DAT is supplied to the current-and-previous field video signal generating section 22 in Step 1 (“Step” will be abbreviated to “S” hereinafter). In response, the current-and-previous video signal generating section 22 in S2 interpolates horizontal lines for the video data in the current field F(k), so as to generate the current field video signal DAT1. In S2, the current-and-previous video signal generating section 22 also generates the previous field video signal DAT0 by interpolating horizontal lines based on the pre-stored video data of the previous field F(k−1).

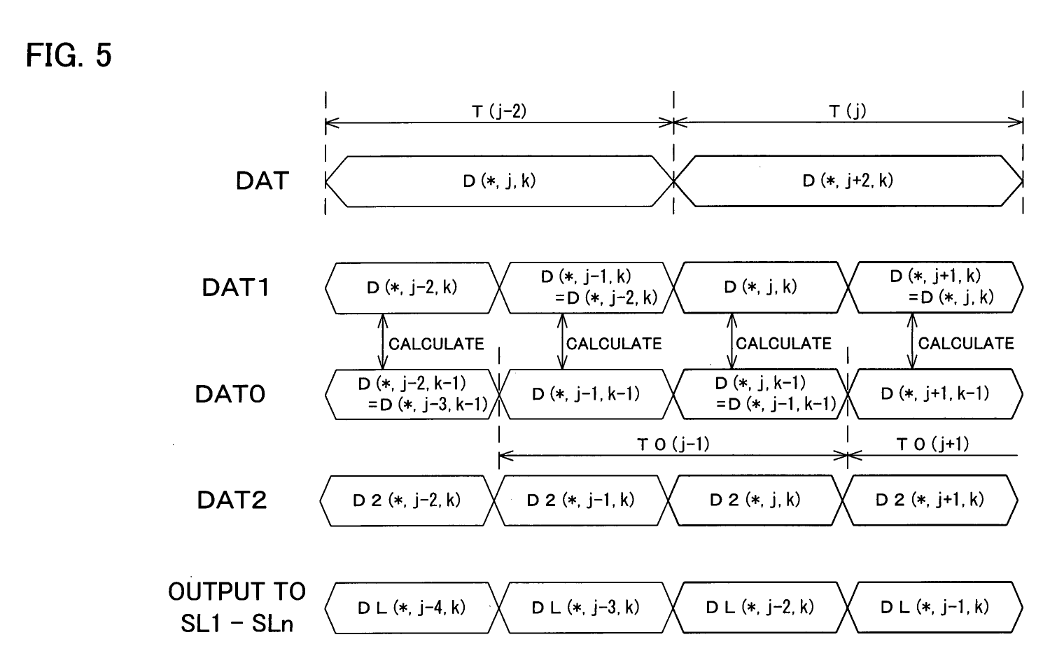

For example, in the present embodiment, the video data of one horizontal line is outputted twice to interpolate horizontal lines, as shown in FIG. 5. In the example of FIG. 5, the current-and-previous field video signal generating section 22 outputs the current field video signal DAT1 after an elapsed period of one horizontal line of the video signal DAT.

Thus, the video data D(*, j, k) supplied to the current-and-previous field video signal generating section 22 in time T(j−2) is outputted in time T(j) as video data D(*, j, k) and video data D(*, j+1, k) in the current field video signal DAT1.

The current-and-previous field video signal generating section 22 interpolates horizontal lines based on the stored video data of the previous field F(k−1), so as to generate the previous field video signal DAT0. Thus, in time T(j), the current-and-previous video signal generating section 22 outputs video data D(*, j, k−1) and video data D(*, j+1, k−1) as the previous field video signal DAT0.

In response to the previous field video signal DAT0 and current field video signal DAT1 supplied from the current-and-previous field video signal generating section 22 in S2, the arithmetic circuit in S3 generates correction video data D2(i, j, k) based on a data pair corresponding to the same pixel PIX (i, j) in the video data DAT0 and DAT1. The correction video data D2(i, j, k) is supplied to the pixel PIX (i, j).

The correction video signal DAT2 generated by the arithmetic circuit 23 in the modulation-driving processing section 21 is sampled by the data signal line driving circuit 3 in the next field F(k+1), so as to extract video data D2(*, j, k) of the correction video signal DAT2 in S4. In S5, the data signal line driving circuit 3 outputs a driving signal DL(*, j, k) according to the video data D2(*, j, k) sampled in S4. The driving signal DL(*, j, k) is outputted to the respective data signal lines SL1-SLn. As a result, the pixel array 2 of the image display device 1 displays an image according to the video signal DAT. Note that, in the example of FIG. 5, the data signal line driving circuit 3 outputs the driving signal DL(*, j, k) after an elapsed period of two horizontal lines of the correction video signal DAT2.

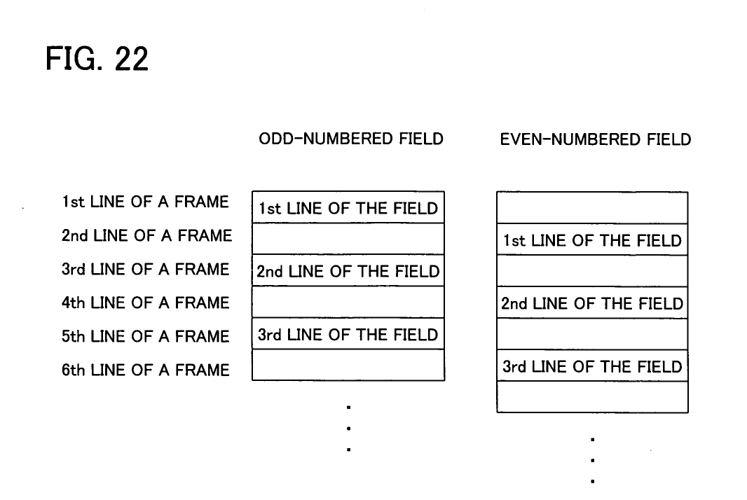

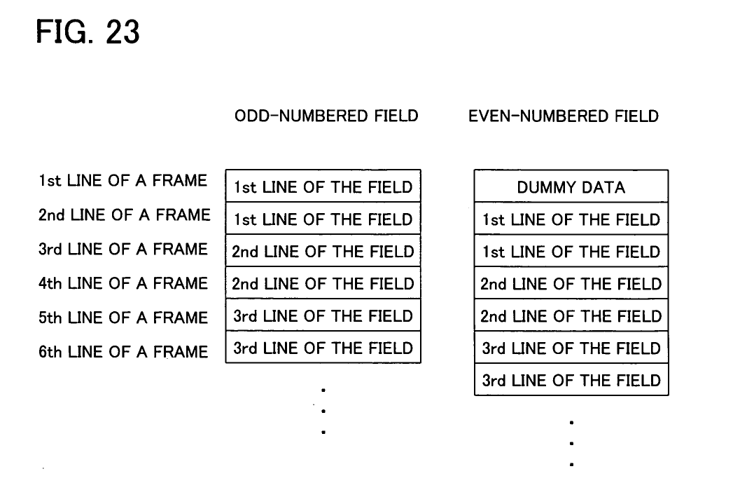

Referring to FIG. 22, in an arrangement where correction is followed by interpolation, a pair of video data for generating particular correction video data undesirably matches a pair of video data based on which different correction video data is generated by interpolation.

Meanwhile, in a system of data transfer where a frame is divided into a plurality of fields, a sequence of scanning horizontal lines is different between fields when data is successively transferred from one field to another. Accordingly, the horizontal line used as a reference line of interpolation is also different between different fields. It follows from this that a pair of horizontal lines created in each field by interpolating a horizontal line is defined differently between the fields of the frame.

Thus, even if a pair of video data is selected that can properly create correction video data for a particular horizontal line in a given field, interpolation of the correction video signal created based on this video data pair produces correction video data that needs to be created based on a different video data pair.

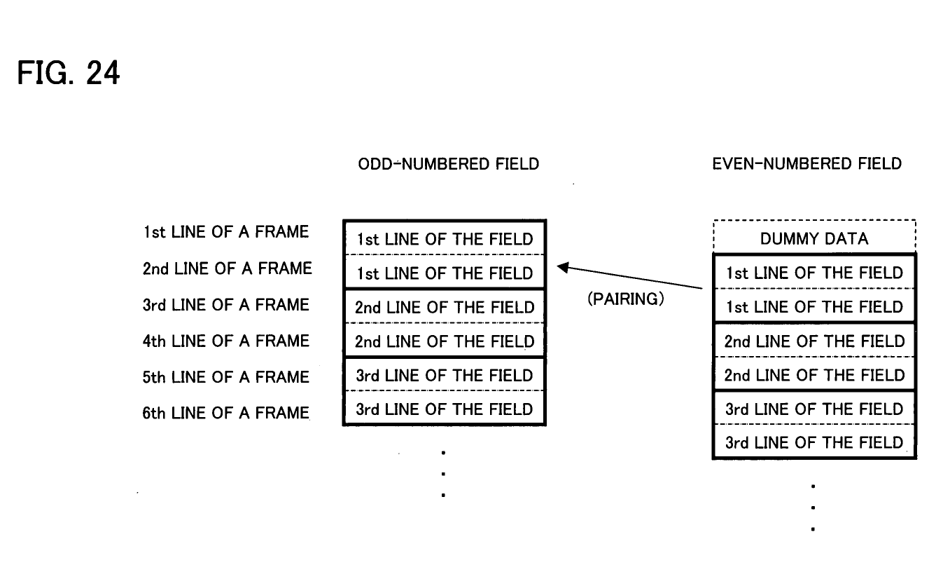

For example, referring to FIG. 24, in a given odd-numbered field F(k−1), video data D(*, j, k−1) of a horizontal line L(j) (j being any odd number) is referred to to create video data D(*, j+1, k−1) for the next horizontal line L(j+1). In the next even-numbered field F(k), video data D(*, j−1, k) of a horizontal line L(j−1) is referred to to create video data D(*, j, k) for the horizontal line L(j). Note that, in FIG. 24, a horizontal line pair that refers to the same video data is enclosed by bold lines.

In this case, in the even-numbered field F(k), correction video data D2(i, j, k) of the horizontal line L(j) is created based on the video data D(i, j, k−1)=D(i, j+1, k−1) and video data D(i, j, k)=D(i, j−1, k). On the other hand, in the even-numbered field F(k), correction video data D2(i, j+1, k) of the next horizontal line L(j+1) needs to be created based on video data D(i, j+1, k−1)=D(i, j, k−1) and video data D(i, j+1, k)=D(i, j, k). That is, a pair of video data for generating one correction video data contains different information from a pair of video data for generating the other correction video data.

Thus, in the arrangement where correction is followed by interpolation, while it may be possible to properly generate, for example, the correction video data D2(i, j, k) for the horizontal line L(i), the correction video data D2(i, j+1, k) for the next horizontal line L(j+1) cannot be created properly.

On the other hand, in the present embodiment, horizontal lines are interpolated before the arithmetic circuit 23 creates the correction video signal DAT2. This enables the arithmetic circuit 23 to select a video data pair from the video data of the previous field video signal DAT0 and the current field video signal DAT1, so that each correction video data can be properly created.

For example, referring to FIG. 5, video data D(*, j−2, k) for a horizontal line L(j−2) is outputted twice in time T(j−2), so that the current field video signal DAT1 contains video data D(*, j−2, k) and video data D(*, j−1, k). In time T(j), video data D(*, j, k) for a horizontal line L(j) is outputted twice as video data D(*, j, k) and video data D(*, j+1, k). On the other hand, in the previous field video signal DAT0, video data D(*, j−1, k−1) for a horizontal line L(j−1) is outputted twice as video data D(*, j−1, k−1) and video data D(*, j, k−1) in time T0(j−1), which precedes the time T(j) by the time period in which the current-and-previous field video signal generating section 22 once outputs video data of one horizontal line. In time T0(j+i), which is equal in length to time T0(j−1), video data D(*, j+1, k) for a horizontal line L(j+1) is outputted twice as video data D(*, j+1, k−1) and video data D(*, j+2, k−1).

The arithmetic circuit 23 generates correction video data D2(*, j, k) based on the video data D(*, j, k−1) of the previous field video signal DAT0 and the video data D(*, j, k) of the current field video signal DAT1. The arithmetic circuit 23 also generates correction video data D2(*, j+1, k) based on the video data D(*, j+1, k−1) of the previous field video signal DAT0 and the video data D(*, j+1, k) of the current field video signal DAT1.

Here, the time T(j) does not match time T0(j−1) or time T0(j+1). Thus, while the video data D(*, j, k) and video data D(*, j+1, k) outputted in time T(j) have the same content in the current field video signal DAT1, the video data D(*, j, k−1)=D(*, j−1, k−1) and the video data D(*, j+1, k) of the previous field video signal DAT0, which are respectively outputted in the first half and second half of time T(j), have different contents.

However, because correction is made after interpolation, the driving signal can be modulated to correctly facilitate a grayscale level transition even when the modulation is based on a driving signal according to the current field video signal DAT1 by referring to the video data that is different between the first half and second half. Thus, unlike the arrangement where correction is followed by interpolation, it is possible to prevent modulation error caused by mispairing of compared data, thereby preventing deterioration of display quality caused by modulation error in the image display device 1.

In the following, the line memory 31 and the field memory 32 will be described in more detail with regard to their structures. The line memory 31 of the present embodiment is of a FIFO (First-In First-Out) type, outputting video data at a frequency of 27 [MHz] when the dot clock frequency of the input video signal is 13.5 [MHz]. With this structure, video signal of one horizontal line can be outputted in half the input time, and therefore the time required to twice output the video data of one horizontal line matches the input time for the video data of one horizontal line. As a result, there is no overflow caused by a difference in input and output times, enabling the line memory 31 to twice output the video data of one horizontal line without causing any problem, as shown in FIG. 5.

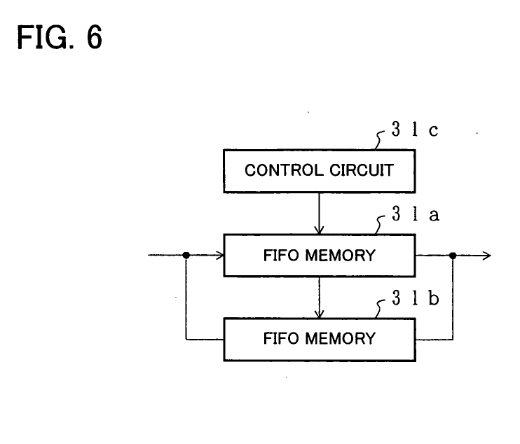

The line memory 31 includes two-line FIFO memories 31a and 31b, and a control circuit 31c, as shown in FIG. 6 for example. The FIFO memories 31a and 31b each store video data of one horizontal line. The control circuit 31c causes incoming video data to be successively stored in one of the line memories 31a and 31b, and while video data of one horizontal line is inputted thereto, causes the other of the line memories 31a and 31b to twice output video data of one horizontal line. When input of video data for one horizontal line is finished, the control circuit 31c switches the roles of the line memories 31a and 31b.

The arbiter 33 causes the field memory 32 to store output video data of the line memory 31 for one field. In the next field, the arbiter 33 outputs the video data of the previous field stored in the field memory 32.

The line memory 31 of the present embodiment outputs video data of one horizontal line twice. In order to accommodate this, the arbiter 33 of the present embodiment stores video data of one field in the field memory 32, and then stores the video data of one field in the field memory 32 by, for example, stopping storing video data for the next horizontal line, or overwriting the video data for the next horizontal line in a recording area in which the video data of the previous horizontal line is stored. In this way, the field memory 32 can have an enough memory capacity to store video data of one field, despite that the line memory 31 outputs video data of one horizontal line twice with the same contents.

In outputting the video data of the previous field, the arbiter 33 first outputs video data of one horizontal line at the same frequency as that used by the line memory 31 to output video data. The arbiter 33 then outputs the video data again as video data for the next horizontal line.

With this structure, video data of a particular horizontal line and the video data of the next horizontal line are outputted at the same frequency as that used by the line memory 31 to output video data. Therefore, the time required to input video data of one horizontal line to the line memory 31 matches the output time in which the arbiter 33 outputs video data of one horizontal line twice. As a result, there will be no overflow caused by a difference in input and output times, enabling the arbiter 33 to twice output video data of one horizontal line as video data of the previous field without any trouble, as shown in FIG. 5.

[Second Embodiment]

The First Embodiment described the structure in which the video data of the current field is stored in the field memory 32 based on the output of the line memory 31. The present embodiment describes a structure in which the video data of the current field is stored in the field memory 32 based on the video signal DAT, as with the line memory 31.

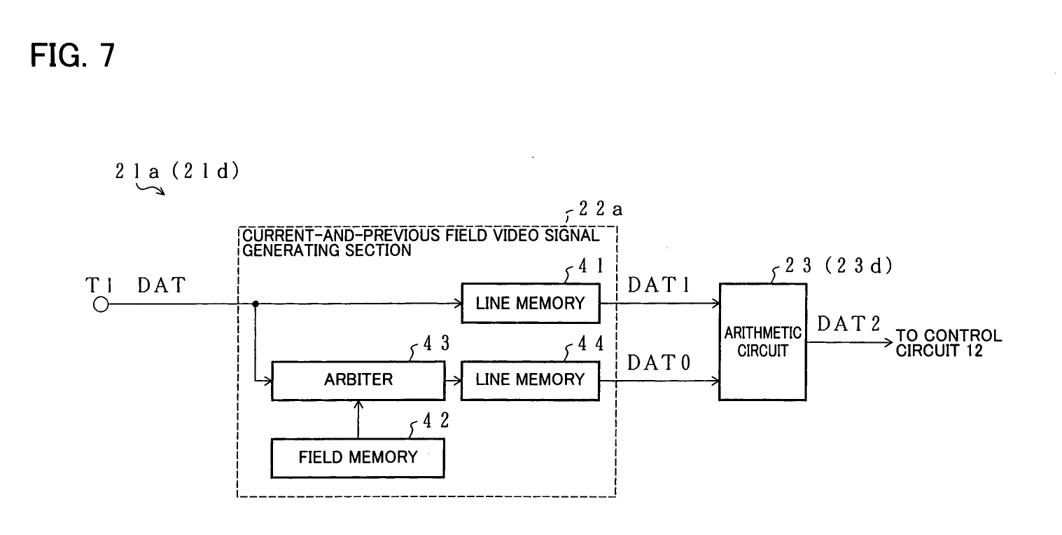

Specifically, a modulation-driving processing section 21a of the present embodiment includes a current-and-previous field video signal generating section 22a, instead of the current-and-previous field video signal generating section 22, as shown in FIG. 7. The current-and-previous video signal generating section 22a includes a line memory 41, a field memory 42, an arbiter 43, and a line memory 43. The line memory 41 has the same structure as the line memory 31 of the First Embodiment. The field memory 42 stores the video data of the current field until the next field. The arbiter 43 writes the video data of the current field in the field memory 42 based on the video signal DAT, and, in the next field, reads and outputs the stored video data in the field memory 42 at the same frequency as the video signal DAT. The line memory 44 has the same structure as the line memory 41, and the input of the line memory 44 is the output of the field memory 42.

With this structure, the line memory 41 outputs the current field video signal DAT1 that was generated by interpolating horizontal lines, as with the line memory 31. The line memory 44, as with the line memory 31, interpolates horizontal lines of the previous field based on the video data of the previous field outputted from the arbiter 43 at the same frequency as the video signal DAT. Therefore, the line memory 44 is able to output the previous field video signal DAT0 that was generated by interpolating horizontal lines, as with the previous-current field video signal generating section 22 of the First Embodiment.

With this structure, as with the First Embodiment, video data is interpolated between horizontal lines before the arithmetic circuit 23 generates the correction video signal DAT2. The arithmetic circuit 23 selects a video data pair from the video data of the previous field video signal DAT0 and current field video signal DAT1 for each correction video data, so that the correction video data is properly generated based on the video data pair so selected.

As a result, as in the First Embodiment, there is no mispairing of the video data referred to when generating the correction video data, and there accordingly will be no modulation error caused by such mispairing. The image display device 1 is therefore able to maintain its display quality without being affected by modulation error.

The present invention differs from the First Embodiment in that the arbiter 43 stores video data of the current field in the field memory 42 based on the video signal DAT, and that the line memory 44 provided on a subsequent stage of the field memory 42 interpolates horizontal lines. This enables the arbiter 43 and the field memory 42 to operate at a lower frequency than that required for the structure in which the arbiter (33) stores the video data of the current field based on the output of the line memory (31) as in the First Embodiment.

For example, when the frequency (dot clock) of the video data in the video signal DAT is 13.5 [MHz], the First Embodiment requires only one line memory for the current-and-previous field video signal generating section 22, but a frequency of 27 [MHz] is required for the video data supplied to the field memory 32 and for the video data outputted by the field memory 32. Thus, in order for the field memory 32 to input and output video data simultaneously, i.e., at different frequencies, the field memory 32 needs to operate at a frequency of 54 [MHz]. On the other hand, in the present embodiment, the input and output frequencies of the field memory 42 are both 13.5 [MHz], enabling the field memory 32 to operate at a frequency of 27 [MHz]. This makes it relatively easier to design the circuit and suppress EMI noise.

[Third Embodiment]

It should be noted here that the image display devices 1 of the First and Second Embodiments modulate the driving signal according to the video data of the current field, so as to facilitate a grayscale level transition from the previous to current field and thereby increase a response speed of the pixels PIX. In practice, however, the pixels that are driven based on the video signal of the current field are not only the pixels PIX corresponding to the video data of the current field but also the pixels PIX corresponding to the video data of the other fields.

For example, in the case of a still image in which the video data corresponding to the same pixels PIX in the previous and current frames are essentially the same, the pixels PIX are also driven by the video data of the previous field. Further, in order to increase a response speed of the pixels PIX, the modulation-driving processing section (21, 21a) facilitates a grayscale level transition from the previous to current field. As a result, despite the fact that the video data of the previous and current frames are essentially the same, a grayscale level transition produces an improper picture on the pixels PIX. This may cause a flicker on the image display device.

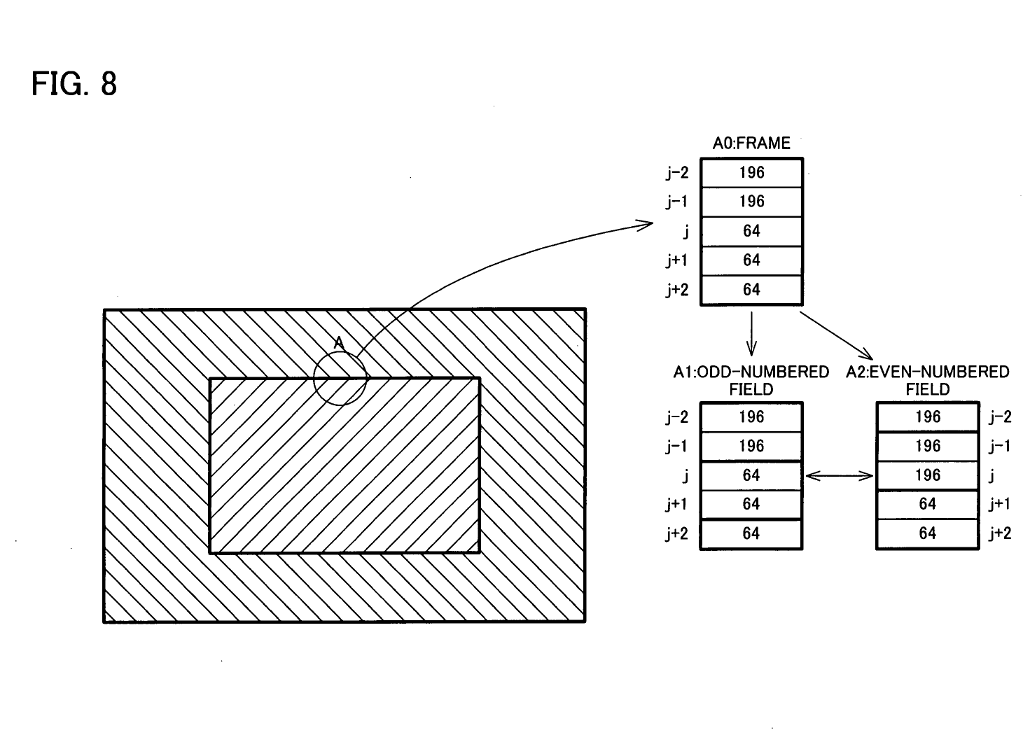

Referring to FIG. 8, the following more specifically describes how flicker is generated, based on an example in which a box of a certain grayscale level (64 in this example) is displayed over a background of a different grayscale level (196 in this example). Specifically, in a frame consisting of an odd-numbered field and an even-numbered field, an area in the vicinity of the edge along a horizontal line, as indicated by area A at the upper side of the box, contains different grayscale levels. As indicated by A0 in FIG. 8, horizontal lines are separated into two grayscale levels (196 and 64) at a certain horizontal line (line j in this example).

It should be noted here that the video signal DAT is an interlace signal, and therefore video data of one frame is separately transmitted in an even-numbered field and an odd-numbered field. For example, when line j is an odd-numbered line, lines j−2, j, j+2 of the horizontal lines shown in A0 are transmitted in an odd-numbered field F(k), and the current-and-previous field video signal generating section (22, 22a) generates lines j−1 and j+1 as in A1 by interpolating horizontal lines based on the video data of the odd-numbered horizontal lines so transmitted. Note that, in the example of FIG. 8, the horizontal line (line j−1, for example) inserted by interpolation has the same grayscale level as a reference horizontal line (line j−2, for example). On the other hand, in an even-numbered field F(k+1), lines j−1 and j+1 of the horizontal lines in A0 are transmitted, and the current-and-previous field video signal generating section (22, 22a) generates lines j and j+2 by interpolation between horizontal lines, as shown in A2.

As noted above, line j defines a borderline. Thus, while the grayscale level of line j has a constant value (64) on a frame basis, it changes between the original grayscale level (64) and the other grayscale level (196) on a field basis (two-way response is caused), owning to the fact that interpolation refers to different horizontal lines between an odd-numbered field and an even-numbered field.

The two-way response does not pose a display problem when the response speed of the pixels PIX is slow, because in this case the slow response speed of the pixels PIX cannot follow the two-way response between odd-numbered and even-numbered fields. However, the two-way response may cause flicker when the response speed of the pixels PIX is increased by facilitating a grayscale level transition as in the image display device 1 of the respective embodiment of the present invention.

In order to avoid flicker, the modulation-driving processing section 21b of the present embodiment compares video signals between the current frame and a field having the video signals on the corresponding positions (“previous corresponding field” in the present embodiment). As the term is used herein, those fields having video signals on the same horizontal lines of the frame are referred to as corresponding fields, so the “previous corresponding field” of any given current field is the earlier of the two previous field of the current field when two fields make up one frame. Based on the result of comparison, the modulation-driving processing section 21b varies the level of facilitation of a grayscale level transition from the previous field to the current field. More specifically, the modulation-driving processing section 21b compares the video data of the current field with the video data of the previous frame corresponding to the same pixels PIX. If these video data substantially match, the modulation-driving processing section 21b reduces the level of facilitation (strength of modulation) of a grayscale level transition from the previous to current field when driving the pixels PIX.

To this end, the modulation-driving processing section 21b of the present embodiment includes a previous-corresponding-field video signal generating circuit 51 in the structure of the modulation-driving processing section 21 or 21a of the respective embodiment. The previous-corresponding-field video signal generating circuit 51 stores the video data of the current field (even-numbered field, for example) until input of video data of the corresponding field (even-numbered field) of the next frame, and outputs a video signal (video signal of the previous-corresponding-field in this embodiment) based on the video data so stored.

The modulation-driving processing section 23b includes an arithmetic circuit 23b instead of the arithmetic circuit 23. The arithmetic circuit 23b compares video data with respect to the same pixels between the current field and the previous-corresponding-field, based on the video signal of the current field and the video signal of the previous corresponding field. If the video data so compared substantially match for the pixel PIX, the arithmetic circuit 23b reduces the strength of modulation. On the other hand, if the video data do not match at all, the arithmetic circuit 23b facilitates a grayscale level transition from the previous to current field without reducing the strength of modulation.

The arithmetic circuit 23b of the present embodiment compares video data between the current field and the previous corresponding field based on the current field video signal DAT1 and the video signal of the previous corresponding field. Here, the current field video signal DAT1 is produced by interpolation between horizontal lines, and therefore the previous-corresponding-field video signal generating circuit 51 interpolates video data between horizontal lines of an adjacent field having video signals on the corresponding positions (previous corresponding field). The second-previous-line video signal generating circuit 51 then outputs the video data after interpolation as a previous-corresponding-field video signal DAT00.

With this structure, the modulation-driving processing section 21b compares the video data for the same pixel between the current field and the previous corresponding field. If the video data substantially match, the modulation-driving processing section 21b reduces the level of facilitation (strength of modulation) of a grayscale level transition from the previous to current field when driving the pixels PIX.

Thus, by comparing the video signal DAT0 of the previous field after interpolation and the video signal DAT1 of the current field, a grayscale level transition for the driving signal of the current field will not be facilitated in excess even when there is a grayscale level transition from the previous to current field, provided that the video data of the current field substantially match the video data of the previous frame corresponding to the same pixels. As a result, a grayscale level transition from an adjacent field (previous corresponding field) to the current field with respect to the video signals of the same horizontal lines will not be facilitated to the normal level (level of facilitation of a grayscale level transition when the strength of facilitation is not reduced), thereby reducing an amount of grayscale level transition.

By thus reducing an amount of grayscale level transition, flicker can be prevented that is caused by a phenomenon in which interpolation of different horizontal lines between different fields brings about a grayscale level transition on a field basis, even though video data are unchanged on a frame basis. As a result, good display quality can be maintained with fewer flickers.

Here, if the video data contains no noise, the arithmetic circuit 23b should simply stop facilitating a grayscale level transition when the video data of the current field matches the video data of the previous frame with respect to the same pixels PIX. In reality, however, noise is generated in the video signal source S0 and the arithmetic circuit 23b, and in a series of circuits and circuit elements in between. Further, the video signal DAT generated by the video signal source S0 contains noise itself. Thus, the modulation-driving processing section 21b of the present embodiment reduces the level of facilitation (strength of modulation) when the video data substantially match.

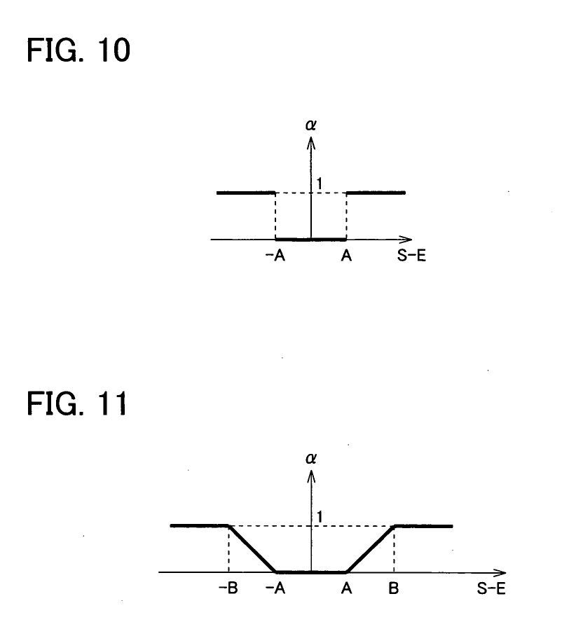

In the following, description is made as to how the arithmetic circuit 23b changes the strength of modulation. In the first method, as shown in FIG. 10, it is determined whether a difference |S−E|, which is the difference of the video data of the current field and the video data of the previous frame corresponding to the same pixels, is above or below a predetermined threshold A. If the difference |S−E| is below the threshold A, the video data of the current field is directly outputted.

To describe in more detail, the correction video data D2 outputted by the arithmetic circuit 23b is denoted as video data D+α·correction amount C, where correction amount C has a predetermined value determined by the video data of the current field and the video data of the previous field.

Under normal conditions, i.e., when the difference |S−E| of the video data is below the threshold A, the arithmetic circuit 23b determines a correction amount C according to combinations of video data D(i, j, k) of the current field and video data (i, j, k−1) of the previous field, by referring to a look-up table (LUT) for example. In addition, the arithmetic circuit 23b calculates the correction video data D2 with α=1, where a indicates the strength of modulation. On the other hand, if the difference |S−E| of the video data is above the threshold A, the arithmetic circuit 23b calculates the correction video data D2 with α=0.

In the foregoing example, the correction video data D2 is calculated after calculating the correction amount C. However, provided that the correction video data D2 calculated with α=0 and α=1 depending on whether the difference |S−E| is above or below the threshold A are outputted, the correction video data D2 may be outputted by referring to look-up tables separately provided for these correction video data D2.

With the NTSC (National Television System Committee) signal of 256 grayscale levels, a threshold A of 8 was confirmed to provide a satisfactory image. It should be noted however that an appropriate value of threshold A varies depending on the quality of the video signal DAT, and therefore a value of threshold A may be selected according to the video signal DAT by determining the quality of the video signal DAT. The quality of video signal DAT may be determined according to, for example, whether or not the video signal source S0 is realized by a receiver, or the availability of radio waves. Other criteria include whether or not the video signal DAT is inputted in analog or digital, or whether or not the video signal source S0 is realized by a video, DVD (Digital Video Disc), or a game machine. The arithmetic circuit 23b may adjust the threshold A according to user instructions. Alternatively, the image display device 1 may include a circuit that determines the quality of the video signal DAT, and the arithmetic circuit 23b may adjust the threshold A according to the result of determination based on the foregoing criteria. This is more convenient for the user.

For a simpler circuit structure, the foregoing first method decides whether to carry out modulation (selects α=0 or 1) depending on whether the difference |S−E| of the video data is above or below the threshold A. In the second method, however, a may take not only the binary value of 0 or 1, but also intermediate values according to the difference |S−E| of the video data.

In the example of FIG. 11, α=0 when the difference |S−E| of the video data is below the threshold A, and α=1 when the difference |S−E| of the video data is above a threshold B. For the values of |S−E| between A and B, α is set according to a function F(|S−E|) with upper and lower limits of 0 and 1, respectively. In FIG. 11, A=8, and B=16. For the value of α, the following relationships are used.

|S−E|=9→α=⅛

|S−E|=10→α=2/8

|S−E|=11→α=⅜

|S−E|=12→α=4/8

|S−E|=13→α=⅝

|S−E|=14→α=6/8

|S−E|=15=⅞

By evaluating image quality of the image display device 1 under these settings of the arithmetic circuit 23b, it was found that the quality of display using an NTSC signal was as excellent as that obtained by the first method.

The foregoing described the case where the threshold A does not take the value of 0. However, the threshold A may be set to 0 in the second method. In this case, substantially the same effects can be obtained when the setting is such that the value of a is smaller when the difference |S−E| of the video data is below the threshold B than when it is above the difference |S−E|.

For optimum modulation strength, a should be equal to 0 when the difference |S−E| of the video data is 0, irrespective of whether the threshold A is 0 or not. This ensures good display quality with fewer flickers. In this case, a may be determined as a function of (S−E)².

Unlike the first method, the second method sets difference values for the threshold A and threshold B, and the value of a is set as a function of F(|S−E|) for values of the difference |S−E| of the video data falling between threshold A and threshold B. The benefit of this is that a varies more gradually than that when threshold A=threshold B as in the first method.

This is more advantageous than the first method in which a takes the value of either 0 or 1 according to the threshold A, and a false contour is generated according to the presence or absence of modulation. In the second method, a varies more gradually, and false contours are suppressed. Thus, with the second method, high display quality is maintained even when displaying a picture with gradations, such as the human skin. Note that, in the second method, the threshold A and threshold B, and function of F(|S−E|) may be changed according to the video signal DAT by determining the quality of the video signal DAT in essentially the same manner as in the first method.

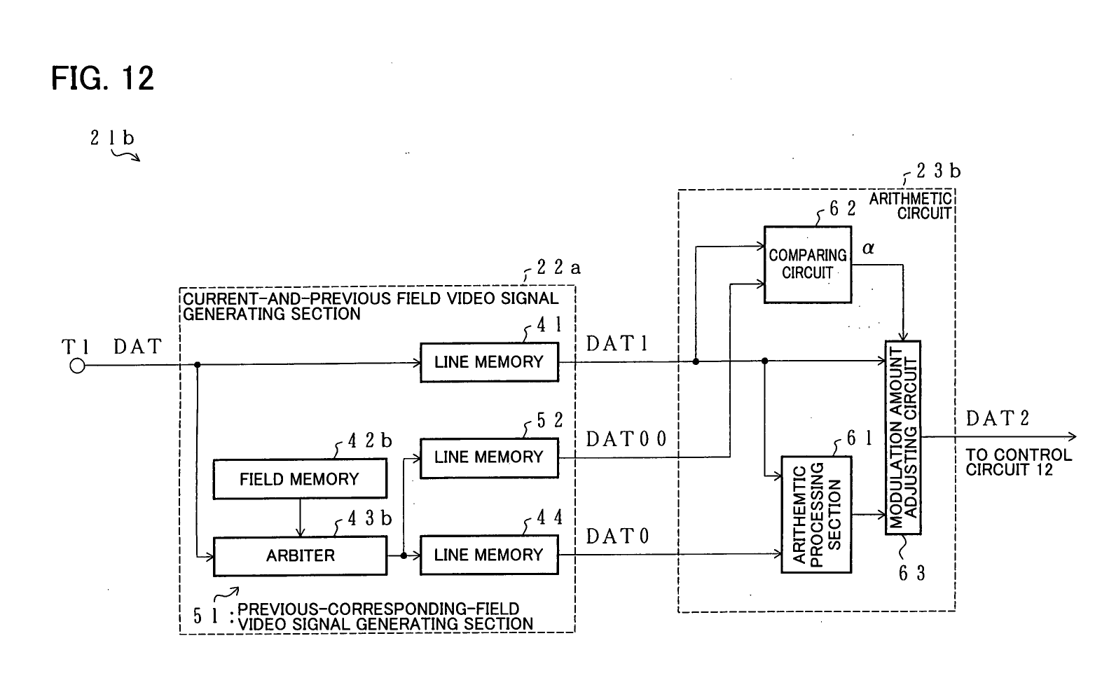

Referring to FIG. 12, the following describes an exemplary structure of the modulation-driving processing section 21b in which the previous-corresponding-field video signal generating circuit 51 is additionally provided in the modulation-driving processing section 21a of the Second Embodiment, and the arithmetic circuit 23b is provided instead of the arithmetic circuit 23.

Specifically, in this structure; a single field memory is used to realize the functions of the previous-corresponding-field video signal generating circuit 51 and the current-and-previous field video signal generating circuit 22a, i.e., the function of the previous-corresponding-field video signal generating circuit 51 to store the video data of the current field (even-numbered filed, for example) until input of video data for an adjacent field (even-numbered field) having the video signal on the same horizontal lines, and the function of the current-and-previous video signal generating circuit 22a to store the video data of the current field until the next field. The field memory is provided instead of the field memory 42 shown in FIG. 7, and is realized by a field memory 42b for storing video data of two fields.

Further, instead of the arbiter 43, an arbiter 43b is provided that writes and reads data in and from the field memory 42b. The arbiter 43b stores video data of the current field F(k) in the field memory 42b based on the video signal DAT. In the next field F(k+1), the arbiter 43b stores video data of the field F(k+1) in a recording area of the field memory 42b different from the one storing the video data of the field F(k). Further, the arbiter 43b reads the video data of the previous-corresponding-field F(k−2) and the video data of the previous field F(k−1), and outputs these video data by doubling the frequency of the dot clock of the video signal DAT.

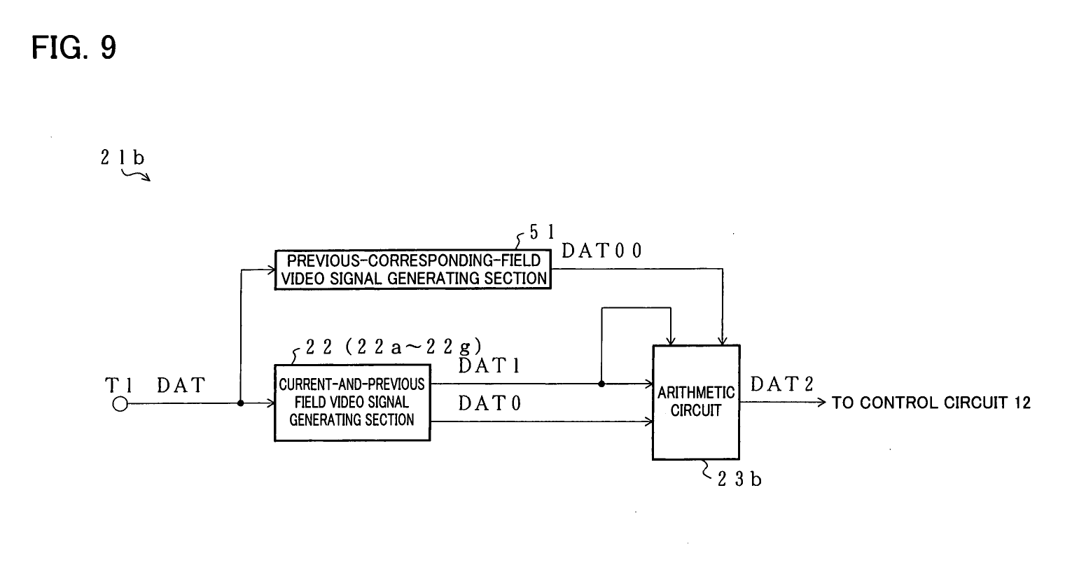

The previous-corresponding-field video signal generating circuit 51 includes a line memory 52. The line memory 52 interpolates horizontal lines based on the video data of the previous-corresponding-field F(k−2) in an output signal FM produced by the field memory 42b and outputted through the arbiter 43b. After interpolation, the line memory 52 outputs the signal as a previous-corresponding-field video signal DAT00. In the example of FIG. 12, the field memory 42b, the arbiter 43b, and the line memory 52 together correspond to the previous-corresponding-field video signal generating circuit 51 shown in FIG. 9.

Further, a line memory 44 is provided as in the Second Embodiment that interpolates horizontal lines based on the video data of the previous field F(k−1) in the output signal FM of the field memory 42, and outputs the interpolated signal as a previous field video signal DAT0.

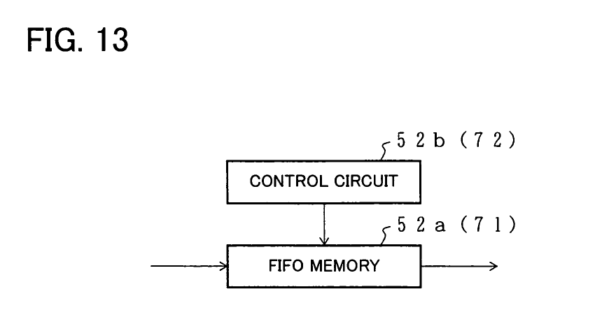

In the line memories 52 and 44, the input signal and output signal have the same frequency. The arbiter 43b outputs video data of one horizontal line first to one of the line memories 52 and 44 and then to the other. Thus, after receiving a signal of one horizontal period, the arbiter 43b does not need to receive another signal for the same time period. Thus, each of the line memories 52 and 44 can be realized with an FIFO line memory 52 for storing video data of one horizontal line, and a control circuit 52b for outputting the data of the FIFO line memory 52a twice, as shown in FIG. 13.

The arithmetic circuit 23b includes an arithmetic processing section 61 as with the arithmetic circuit 23. The arithmetic processing section 61 outputs a correction amount C(i, j, k) for a video data pair of video data D(i, j, k) and video data D(i, j, k−1) of the current field video signal DAT1 and the previous field video signal DAT0, respectively, corresponding to the same pixel PIX(i, j). The arithmetic circuit 23b also includes a comparator 62 and a modulation amount adjusting circuit 63. The comparator 62 compares the current field video signal DAT1 and the previous-corresponding-field video signal DAT00. The modulation amount adjusting circuit 63 generates a correction video signal DAT2 based on: the result of comparison by the comparator 62, a correction video signal DAT2b containing the correction amount C(i, j, k) outputted from the arithmetic processing section 61; and the current field video signal DAT1.

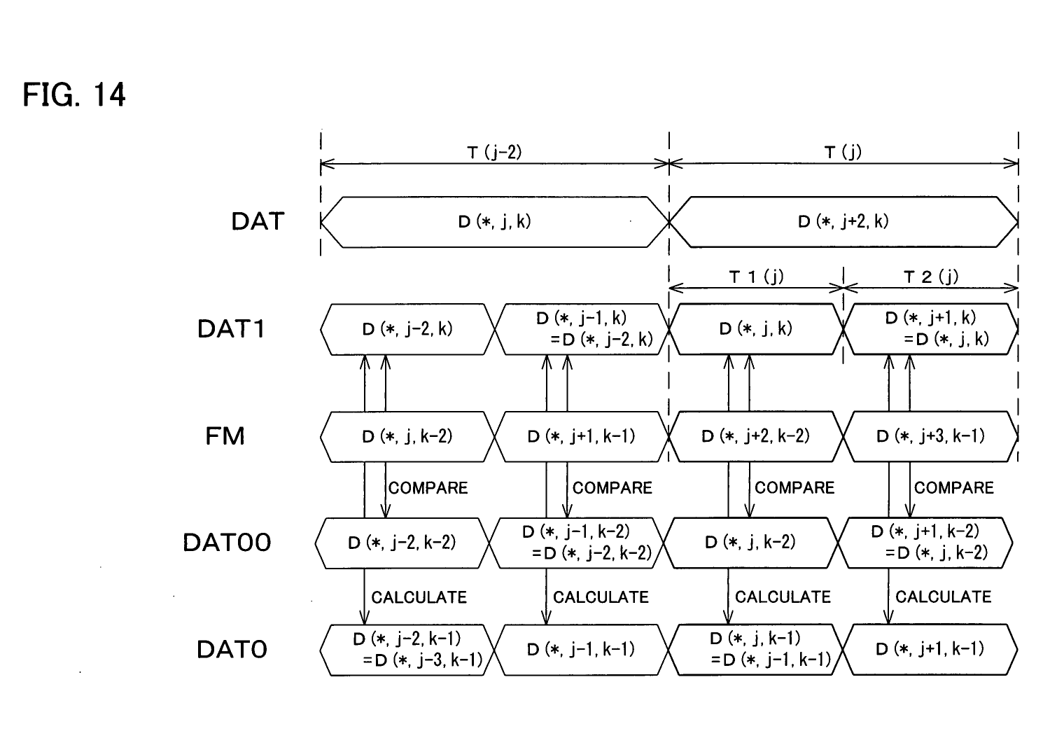

With this structure, the line memory 41, as shown in FIG. 14, interpolates horizontal lines of the video data DAT, and outputs the current field video data DAT1, in the same manner as illustrated in FIG. 5.

The field memory 42b operates differently from FIG. 5. Specifically, the stored video data of the previous field F(k−1) is outputted by doubling the frequency of the dot clock of the video signal DAT, so that the video data of the previous field F(k−1) is outputted in time T2(j) half the period of time T(j) in which the video data of the field F(k) is inputted.

In the example of FIG. 14, the line memories 44 and 52 output video data that lags behind another video data by one horizontal line of the video signal DAT. Thus, the arbiter 43b outputs video data D(*, j+2, k−2) of the previous-corresponding-field F(k−2) in time T1(j), and video data D(*, j+3, k−1) of the previous field F(k−1) in time T2(j), so that the video signals DAT1, DAT0, and DAT00 synchronize one another at the time when they arrive the arithmetic processing section 61 and the comparator 62.

From the output signal FM produced by the field memory 42b, the line memory 44 refers to the video data outputted in time T2 so as to interpolate horizontal lines and output the previous field video signal DAT0. The video signals DAT0 and DAT1 are supplied to the arithmetic processing section 61, where the correction video signal DAT2b containing the correction amount C(i, j, k) for each pixel PIX(i, j) is generated.

From the output signal FM produced by the field memory 42b, the line memory 52 refers to the video data outputted not in time T2(j) but time T1(j) so as to interpolate horizontal lines and output the previous-corresponding-field video signal DAT00.

The comparator 62 compares video data pair of video data D(i, j, k) and video data D(i, j, k−2) of the video data DAT1 and DAT00, respectively, corresponding to the same pixel PIX(i, j), so as to adjust the strength of modulation α(i, j, k). The modulation amount adjusting circuit 63 generates the correction video data D2(i, j, k) based on: a correction amount C(i, j, k) for a pixel PIX(i, j); the strength of modulation α(i, j, k) corresponding to the pixel PIX(i, j); and the video data D(i, j, k) of the current field video signal DAT1.

For example, in a structure according to the foregoing first method, the comparator 62 sets α(i, j, k)=0 when the difference of the video data |D(i, j, k)−D(i, j, k−2)|≦A. Since α(i, j, k)=0, the video data D(i, j, k) of the current field video signal DAT1 is outputted as the correction video data D2(i, j, k) by the arithmetic processing section 61. If, on the other hand, the difference of the video data |D(i, j, k)−D(i, j, k−2)|>A, the comparator 62 sets α(i, j, k)=1 for the arithmetic processing section 61 to output C(i, j, k)+D(i, j, k) as the correction video data D2(i, j, k).

In this manner, the modulation-driving processing section 21b of the present embodiment reduces the strength of facilitation (strength of modulation) of a grayscale level transition when the video data substantially match, thereby suppressing flicker.

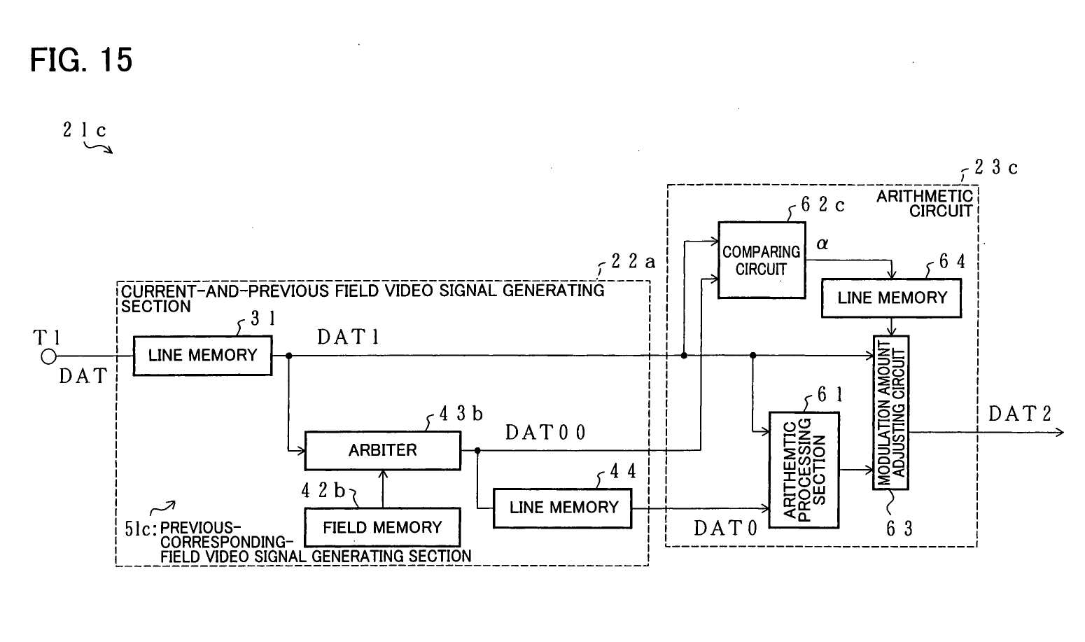

In the structure described above, the strength of modulation α(i, j, k) for each pixel PIX(i, j) is set for the arithmetic processing section 61 in the structure in which the line memory 52 for interpolating horizontal lines is provided on a preceding stage of the comparator 62, and the comparator 62 outputs the strength of modulation α(i, j, k) by comparing the previous-corresponding-field video signal DAT00 and the current field video signal DAT1 for each pixel PIX(i, j). Alternatively, the line memory for interpolating horizontal lines may be provided on a subsequent stage of the comparator 62, as shown in FIG. 15.

FIG. 15 illustrates a structure of a modulation-driving processing section 21c, which is prepared by additionally providing the previous-corresponding-field video signal generating circuit 51 in the modulation-driving processing section 21 of the First Embodiment, and by replacing the arithmetic circuit 23 with the arithmetic circuit 23b.

As in the modulation-driving processing section 21b shown in FIG. 12, the modulation-driving processing section 21c also shares the field memory 42b between the previous-corresponding-field video signal generating circuit 51 and the current-and-previous field video signal generating section 22. Further, the line memory 44 interpolates horizontal lines based on the video data outputted by the field memory 42b in time T2(j), so as to produce the previous field video signal DAT0.

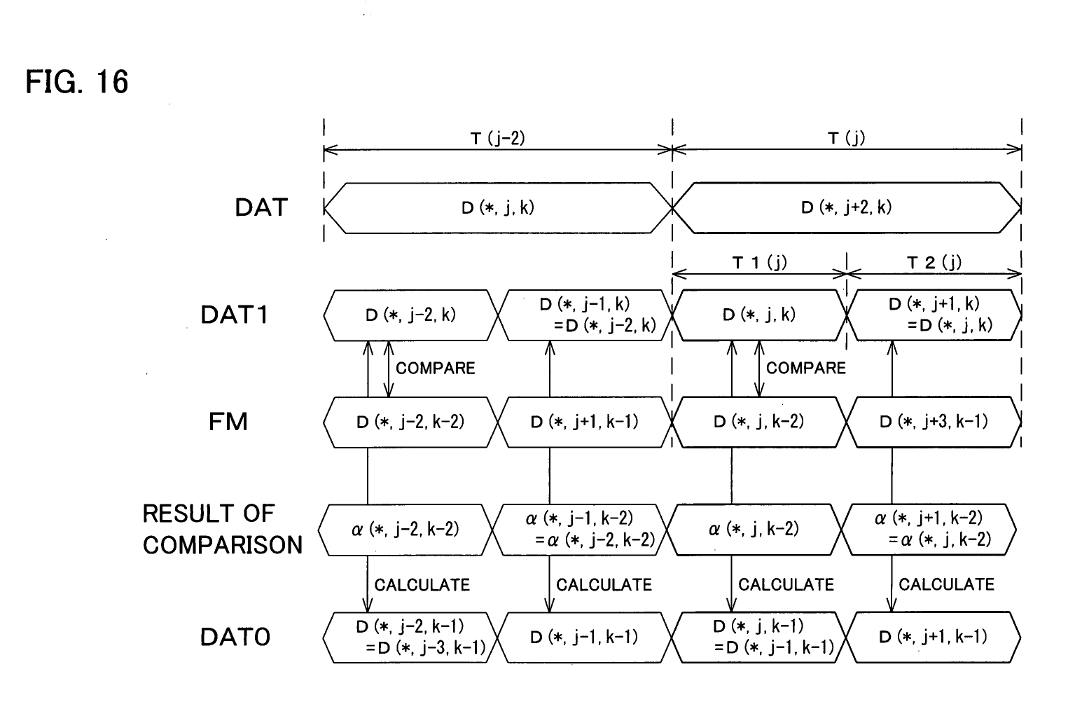

The modulation-driving processing section 21c includes an arithmetic circuit 23c provided with an arithmetic processing section 61, a comparator 62c, and a modulation amount adjusting circuit 63, analogous to those provided in the modulation-driving processing section 21b shown in FIG. 12. The modulation-driving processing section 21c differs from the modulation-driving processing section 21b in that it does not include the line memory 52. Another difference is that the comparator 62c, which is provided instead of the comparator 62, compares the video data (D(*, j, k), for example) of the current field F(k) outputted from the current-and-previous field video signal generating section 22a in time T1(j) with the video data of the previous-corresponding-field F(k−2) outputted from the field memory 42b in time T1(j), i.e., the video data (D(*, j, k−2) in this example) having the same pixels PIX as the video data of the current field F(k), as shown in FIG. 16. Based on the result of comparison, the comparator 62c outputs the strength of modulation α(i, j, k).

The arithmetic circuit 23c further includes a line memory 64 substantially analogous to the line memory 52. The line memory 64 interpolates horizontal lines based on the output signal of the comparator 62c, and outputs the result of comparison to the modulation amount adjusting circuit 63. Note that, the line memory 44 has different numbers of bits from the line memory 52. The number of bits required for the line memory 64 is not for storing video data but for sufficiently storing the result of comparison.

Referring to FIG. 15, the arbiter 43b outputs the video data (D(*, j+3, k−1), for example) of the previous field F(k−1) in time T2(j) and does not output the video data of the previous-corresponding-field F(k−2). In this case, the comparator 62c is unable to compare the previous-corresponding-field video signal DAT00 and the current field video signal DAT1.

It should be noted however that while the previous-corresponding-field video signal DAT00 and the current field video signal DAT1 are of different frames, they belong to the same field. Thus, the result of comparison α(*, j, k) obtained for one horizontal line by comparing the respective video data applied in time T1(j) are the same as the result of comparison α(*, j+1, k) for the next horizontal line. Thus, by causing the line memory 64 to store the result of comparison for one horizontal line and output the result twice as with the line memory 52, the arithmetic circuit 23c is able to properly output the correction video signal DAT2.

In the example described above, the line memory 31 (41) has two FIFO memories 31a and 31b, and outputs video data that lag behind one another by one horizontal line of the video signal DAT, as shown in FIG. 6. However, the present invention is not just limited to this example in any ways.

For example, as with the line memory 52 (44) shown in FIG. 13, the line memory 31 (41) may include an FIFO memory 71 for storing the video data of one horizontal line, and a control circuit 72 for selecting one of the video data stored in the FIFO memory 71 and outputting it by doubling the frequency of the dot clock of the video signal DAT.

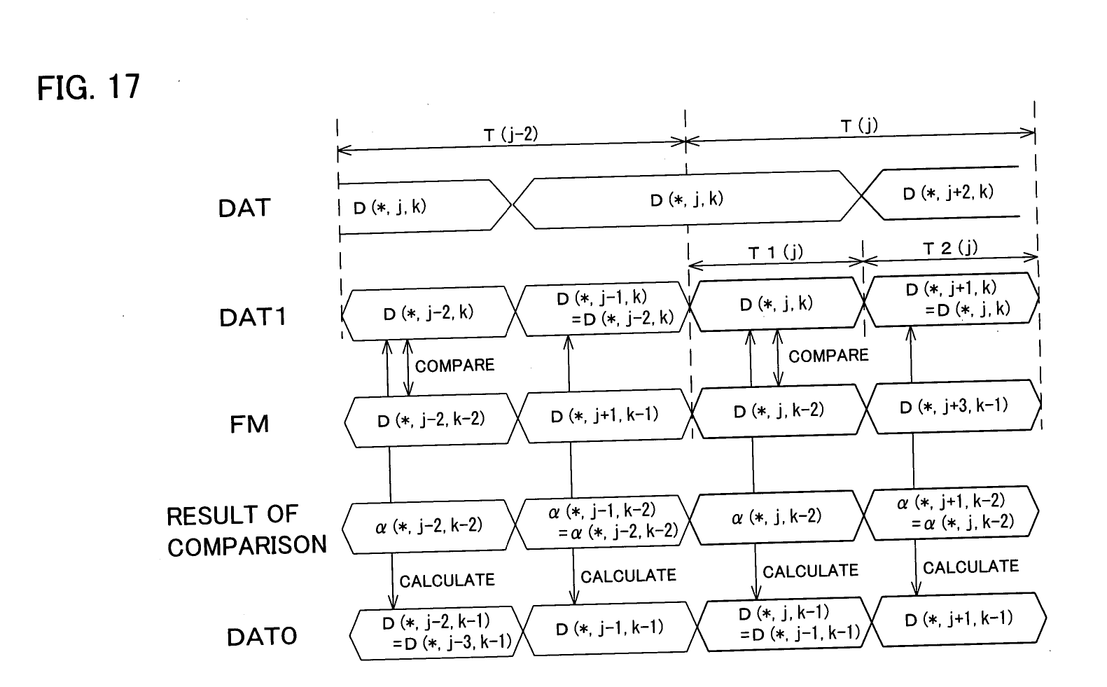

In this case, as shown in FIG. 17, the video signal DAT leads the current field video signal DAT1 by half the horizontal line of the video signal DAT when the FIFO memory 71 first outputs the video data D(*, j, k) for one horizontal line. Here, the phase difference is reduced by half the period of the dot clock every time the line memory 31c outputs the video data. However, since the video signal leads the current field video signal DAT1 by half the horizontal line at the first output, the FIFO memory 71 is able to output video data D(*, j, k) of one horizontal line while storing video data D(*, j, k) of one horizontal line.

The FIFO memory 71 successively receives the video data D(*, j, k) and video data D(*, j+1, k) from one horizontal line to another. However, the output dot clock of the FIFO memory 71 is higher than the dot clock of the video signal DAT. Thus, the capacity of the FIFO memory 71 may be increased by, for example, increasing the memory capacity for one horizontal line by an amount of one video data, so that the first video data D(1, j, k) of the second output can be outputted before the video data D(1, j, k) of the first output is overwritten. This enables the FIFO memory 71 to output the video data D(*, j, k) of the second output before the recording area for the video data D(*, j, k) is overwritten.

[Fourth Embodiment]

In the Third Embodiment, the video data of the current field is compared with the video signal of an adjacent field receiving the video signal on the same pixels PIX. If the video data substantially match, the strength of facilitation (strength of modulation) of a grayscale level transition from the previous to current field is reduced when driving the pixels PIX. In this way, on the frame basis, an amount of grayscale level transition is reduced when the video data have hardly changed, thereby maintaining good display quality with fewer flickers.

The present embodiment adopts a different structure including a modulation-driving processing section 21d (see FIG. 1 or FIG. 7), in which adverse effects of flicker, particularly one detrimental to display quality is prevented.

Specifically, when the arithmetic circuit (23-23c) facilitates a grayscale level transition from the previous to current field so as to maximize the response speed of the pixels PIX(i, j), the response speed in one direction may become faster than the response speed in the other direction when there is a two-way response.

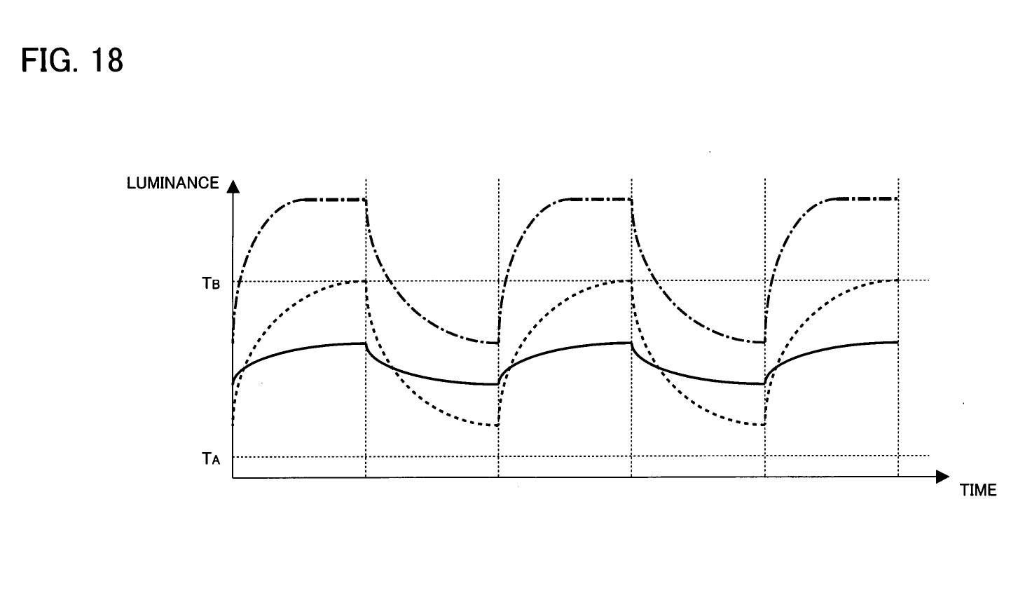

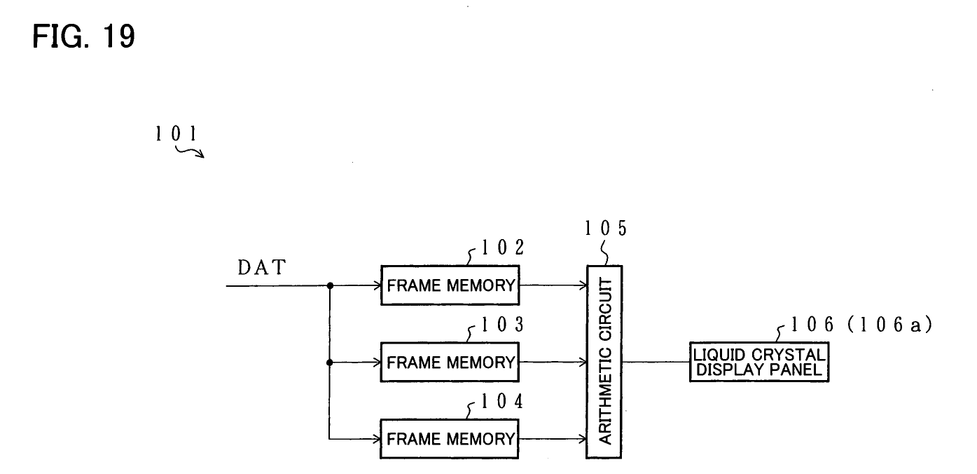

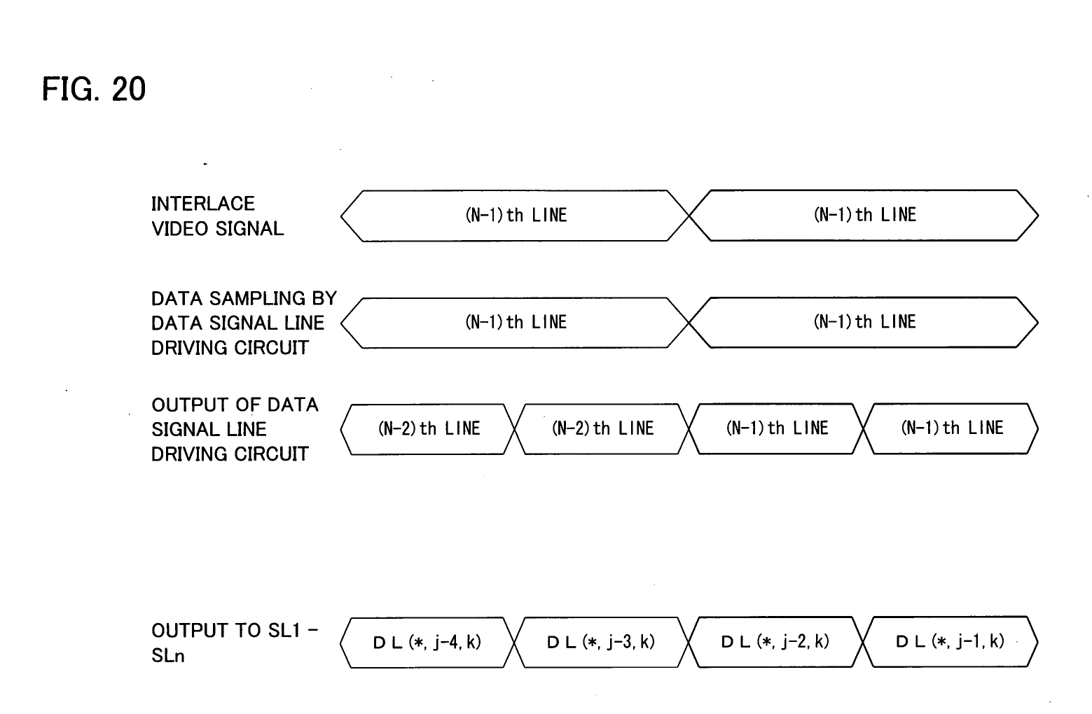

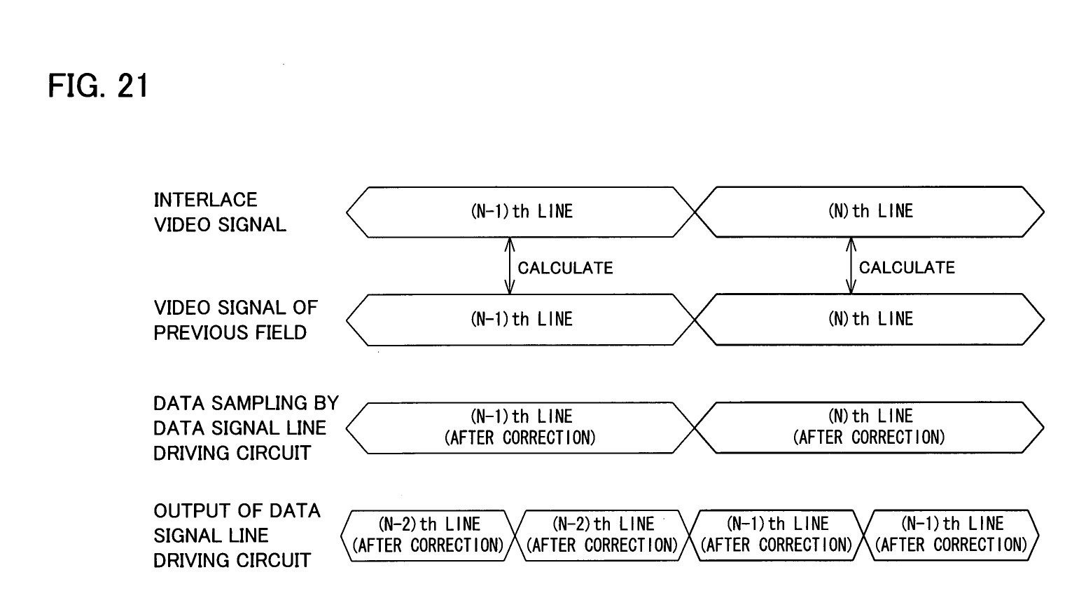

For example, as shown in FIG. 18, when a two-way response occurs with a grayscale level transition from a grayscale level (luminance) TA to TB occurring faster than from TB to TA, the mean value of grayscale level becomes greater than the intermediate value of grayscale level TA and TB. In particular, when the difference in speed of grayscale level transition is large, the mean value of grayscale level exceeds the higher grayscale level TA.

In this case, the grayscale level of the pixel PIX is greater than either of the grayscale levels TA and TB, making it noticeable to the observer and deteriorating display quality of the image display device. For example, when the box in FIG. 8 is displayed at a grayscale level TB on the background at a grayscale level TA, the pixels PIX in the edge area A have a grayscale level higher than the background of the box, and these pixels PIX appear bright.

The modulation-driving processing section 21d of the present embodiment prevents such an undesirable phenomenon by reducing the strength of facilitation of a grayscale level transition for the transition of a two-way response occurring faster, so that the rate of the faster grayscale level transition approaches that of the slower grayscale level transition.

The strength of facilitation of a grayscale level transition is reduced to such a degree that the integrated value of luminance for a pixel PIX falls within a range of luminance TA and luminance TB when the pixel PIX is driven two ways between the luminance TA and the luminance TB.

Therefore, the modulation-driving processing section 21d facilitates the grayscale level transition from the previous to current field in such a manner that the integrated value of luminance for a pixel PIX falls within a range of luminance TA and luminance TB when the pixel PIX is driven two ways between the luminance TA and the luminance TB.

Thus, even when the result of driving the pixels PIX of all the frames by modulating the video data of the current field according to the video data of the previous field has caused a particular pixel (i, j) to be driven on a field basis, the luminance of the pixel PIX (i, j) stays between the maximum value and the minimum value of the luminance of the video data D(i, j, k) of the respective field.

Hence, the luminance of the pixel PIX(i, j) does not become brighter or darker than its video data D(i, j, k) or the video data D(i, j, k) of an adjacent pixel PIX. As a result, good display quality can be maintained for the image display device.

In the present embodiment, the arithmetic circuit 23d produces correction video data D2(i, j, k) referring to the respective video data D(i, j, k−1) and D(i, j, k) of the previous field video signal DAT0 and the current field video signal DAT1. Further, the grayscale level transition is facilitated to the extent as determined by the method of calculation for producing the correction video data D2(i, j, k) or by the data referred to to produce the correction video data D2(i, j, k).

Thus, unlike the Third Embodiment, good display quality can be maintained without additionally providing a member for maintaining good display quality with fewer flickers.

Further, in the present embodiment, the grayscale level transition is facilitated to such an extent that substantially the same response speed is obtained for all grayscale level transitions. More specifically, the strength of facilitation of grayscale level transitions is set so that the response speed of the respective grayscale level transition substantially matches the response speed of the slowest grayscale level transition with the maximum facilitation.

In this way, substantially the same response speed can be obtained for all grayscale level transitions. This prevents the problem caused when the response speed is different for different grayscale levels, i.e., the problem of a moving object seen through when pixels with high response speeds and slow response speeds coexist. As a result, good display quality can be maintained.

[Fifth Embodiment]

The foregoing First through Fourth Embodiments described the case where the video data D(*, j, k) of a particular horizontal line is outputted as the video data D(*, j+1, k) of the next horizontal line when generating the current field video signal DAT1 by interpolation of horizontal lines for the video data of the current field and when generating the previous field video signal DAT0 by interpolation of horizontal lines for the video data of the previous field.

The present embodiment, on the other hand, employs a different interpolation method to interpolate video data in the current field and previous field, as described below. Note that, the description below is based on a structure shown in FIG. 9 as an example, but is also applicable to any of the modulation-driving processing sections (21-21d) described above.

Specifically, a modulation-driving processing section 21e of the present embodiment includes a video signal generating section 22e, instead of the current-and-previous field video signal generating sections (22-22a). The video signal generating section 22e averages video signals of two horizontal lines in each of the current and previous fields to generate a video signal, and interpolates a horizontal line based on the video signal so generated.

In order to generate video data D(*, j−1, k−1) for a horizontal line L(j−1) by interpolating a horizontal line between horizontal lines L(j−2) and L(j) of the previous field F(k−1), the video signal generating section 22e averages video data D(i, j−2, k−1) and video data D(i, j, k−1).

Similarly, in order to generate video data D(*, j−1, k) for a horizontal line L(j−1) by interpolating a horizontal line between horizontal lines L(j−2) and L(j) of the current field F(k), the video signal generating section 22e averages video data D(i, j−2, k) and video data D(i, j, k).

In this manner, a horizontal line is generated between the current line and the previous line by averaging the two horizontal lines in each field. This is more advantageous in displaying smooth pictures than interpolating a horizontal line based on video data containing the same information. Further, by taking an average, interpolation can be carried out with a simpler circuit structure, compared with referring to other video signals, or compared with other calculations based on two horizontal lines. As a result, good display quality can be obtained for the image display device 1 with a relatively simple circuit structure.

Instead of the current-and-previous field video signal generating section 22e, a video signal generating section 22f may be provided. The video signal generating section 22f carries out interlace-progressive conversion in the current field based on video data of the current field, so as to generate the current field video signal DAT1. Similarly, the video signal generating section 22f carries out interlace-progressive conversion in the previous field based on video data of the previous field, so as to generate the current field video signal DAT0.

When generating video data D(*, j−1, k−1) for a horizontal line L(j−1) by the interpolation of horizontal lines L(j−2) and L(j) in the previous field F(k−1), the video signal generating section 22f generates video data D(i, j−1, k−1) of a pixel PIX(i, j−1) based on more than one video data in the horizontal line L(j−1) and more than one video data in the horizontal line L(j).

Similarly, when generating video data D(*, j−1, k) for a horizontal line L(j−1) by the interpolation of horizontal lines L(j−2) and L(j) in the current field F(k), the video signal generating section 22f generates video data D(i, j−1, k) of a pixel PIX(i, j−1) based on more than one video data in the horizontal line L(j−1) and more than one video data in the horizontal line L(j).

In this manner, a video signal for a pixel of the interpolated horizontal line is generated based on video data for a plurality of pixels in one of two horizontal lines of a field, and video data for a plurality of pixels in the other horizontal line. Thus, the calculation of interpolation takes into account the pixels in the adjacent horizontal lines, enabling the interpolation to be carried out based on the presence or absence of a diagonal line in the display, for example. The enables horizontal lines to be interpolated in each of the previous and current fields more smoothly than interpolating horizontal lines based on video data containing the same information, or interpolating horizontal lines by calculating an average. As a result, improved display quality can be obtained for the image display device 1.

Instead of the current-and-previous field video signal generating section 22f, a video signal generating section 22g may be provided. The video signal generating section 22g carries out interlace-progressive conversion in the current field based on the video data of the leading and trailing fields of the current field, so as to generate the current field video signal DAT1. Similarly, the video signal generating section 22g carries out interlace-progressive conversion in the previous field based on the video data of the leading and trailing fields of the previous field, so as to generate the previous field video signal DAT0.

In the present embodiment, video data is interpolated between horizontal lines of the previous and current fields based on video data of more than one field. This enables horizontal lines to be more smoothly interpolated in the previous and current fields, thereby further improving display quality of the image display device 1. Further, because the calculation of interpolation takes into account video data of more than one field, it is possible to determine whether the displayed image is a still image or not. In the case of a still image, the video data of the previous field may be used for interpolation. In this case, flicker can be prevented.

In the foregoing embodiments, the video data are transferred by time division for each horizontal line in each field. However, substantially the same effects can be obtained when the video data are transferred line by line. Further, in the foregoing embodiments, the display element used a liquid crystal cell of a vertically aligned mode and of a normally-black mode. However, the present invention is not limited to this example. Substantially the same effects can be obtained when the display element is adapted to facilitate a grayscale level transition for increased response speed by modulation-driving, or to drive all the pixels PIX on a field basis for improved luminance.

It should be noted here that the liquid crystal cell has a slower response speed than the CRT, and the response of the liquid crystal cell may not finish within the rewrite time (16.7 msec), which corresponds to the normal frame frequency of 60 Hz. Thus, the driving signal should preferably be modulated to facilitate a grayscale level transition. Further, by taking advantage of the fact that the light source of the liquid crystal cell consumes power even during dark display, luminance can be increased by driving all the pixels PIX on a field basis, without increasing power consumption. The liquid crystal cell is therefore particularly preferable as the display element.

Further, in the foregoing embodiments, the respective elements of the modulation-driving processing section are realized by hardware. However, the present invention is not just limited to this implementation. For example, some of or all of the elements may be realized by a program for realizing the described functions, by combining the program with hardware (computer) for running the program.

For example, in order to realize the modulation-driving processing section (21-21g), a computer connected to the image display device 1 may be used as the device driver for driving the image display device 1. When the modulation-driving processing section is realized by a converter board provided internal or external to the image display device 1, and when operations of the circuit realizing the modulation-driving processing section are changeable by rewriting the program in firmware for example, the software may be distributed to change the circuit operations so that the circuit can operate as the modulation-driving section of the respective embodiment.

In this way, the modulation-driving processing section of the respective embodiment can be realized only by running a program using hardware for realizing the described functions.

More specifically, when using software, the modulation-driving processing sections 21 through 21g of the foregoing embodiments may be realized by arithmetic means such as a CPU or hardware for realizing the described functions, so as to execute a program code stored in a memory such as ROM or RAM, and to control peripheral circuits such as input-output circuits.

In this case, hardware carrying out part of the process may be combined with the arithmetic means for executing a program code for controlling the hardware or for carrying out other processes. Even for those elements described as hardware, hardware for carrying out part of the process may be combined with the arithmetic means controlling the hardware or carrying out other processes. Note that, the arithmetic means for executing the program code may be used alone, or in combination with other arithmetic means by being connected via a bus inside the device, or via other communication paths.

The program code that can be run directly by the arithmetic means, or program data that can generate the program code, for example, by being uncompressed may be stored and distributed in a recording medium. Alternatively, the program (program code or program data) may be run by the arithmetic means after it is transmitted via communications means using a wire or wireless communications path.

The program is transmitted through the communications path in the form of a signal stream as it propagates through different transmission media of the communications path. When transmitting the signal stream, a transmitter may be used to modulate a carrier wave based on the signal stream containing the program, so as to superimpose the signal stream on the carrier wave. In this case, the signal stream is restored as the receiver demodulates the carrier wave. Alternatively, the transmitter may send the signal stream in packets as a digital data stream. In this case, the receiver restores the signal stream by concatenating the received packets. Further, the transmitter may send the signal stream by multiplexing it with another signal stream by time-division, frequency-division, or code-division, etc. In this case, the receiver restores the signal stream by extracting individual signal stream from the multiplexed signal stream. In any case, the same effects can be obtained as long as the program is transmitted via communications paths.

The recording medium for distributing the program may or may not be detachable (removable) as long as the program is distributed, even though a detachable recording medium is more preferable. Further, the recording medium may or may not be rewritable (writable), or may or may not be volatile, as long as the program is stored therein. The recording method and the shape of the recording medium are not limited either. Examples of the recording medium include tapes such as a magnetic tape and cassette tape; magnetic disks such as a floppy disk™ and hard disk; and other types of disks, including CD-ROM, magneto-optical disk, mini disk (MD), and digital video disk (DVD). The recording medium may be realized by a card such as an IC card and optical card, or semiconductor memory such as a mask ROM, EPROM, EEPROM, and flash ROM. Alternatively, the recording medium may be a memory formed in the arithmetic means such as CPU.

The program code may be a code for instructing the entire procedure of the processes to the arithmetic means. Alternatively, in the presence of a basic program (for example, operating system or library) for executing part or all of the processes by being called upon by a predetermined procedure, the procedures of the processes may be replaced with a code or a pointer for instructing the arithmetic means to call the basic program.

The program may be stored in a recording medium in a form accessible and executable by arithmetic means as in a real memory. Alternatively, the program may be stored in a form installed in a local recording medium (for example, real memory, hard disk) that provides all-time access to the arithmetic means. Further, the program may be stored in a form in a network or portable recording medium, before it is installed in the local recording medium. Further, the program is not just limited to a complied object code, and may be stored as a source code, or an intermediate code generated in the process of interpretation and compiling. In any case, the same effects can be obtained irrespective of the form the program is stored in the recording medium, so long as the information can be converted into a form that can be run by the arithmetic means, for example, by being uncompressed, decoded, interpreted, complied, linked, or placed in a real memory, or by a combination of these processes.

As described, the present invention provides a method for driving a group of pixels in a display device (1) to display an image of a respective frame based on an interlace signal for displaying an image of a respective frame from video signals of a plurality of fields, the method including the steps of: (I) generating driving signals based on video signals of a current field, so as to drive the group of pixels for displaying the frame image; (II) modulating the driving signals for driving the group of pixels, by referring to video signals of a previous field; (III) interpolating video signals for the previous field before modulating the driving signals, so as to generate video signals of one frame; and (IV) interpolating video signals for the current field before modulating the driving signals, so as to generate video signals of one frame, in the step (II), the driving signals being respectively modulated for the group of pixels by referring to video signals of the previous field used to generate the driving signals for the respective pixels.

The method refers to video signals of the previous field, but a group of pixels for displaying an image of one frame are basically driven based on video signals of the current field. Thus, with this method, the display device can have improved luminance, compared with turning OFF pixels corresponding to video signals of the other fields. Further, the method refers to video signals of the previous field to modulate driving signals for the current field. This increases a response speed of the pixels, compared with driving a group of pixels based solely on the video signals of the current field.

Further, the method interpolates video signals of the previous field and current field before the modulation step, so as to generate video signals of one frame for the previous field and the current field. In the modulation step, the driving signals are respectively modulated for the pixels by referring to video signals of the previous field used to generate the driving signals for the respective pixels.

By thus driving a group of pixels of one frame on a field basis, luminance can be increased. Further, by modulating the driving signals based on video signals of the previous field, a response speed of the pixels can be increased. Despite these advantages, modulation error will not be caused by mispairing of video signals, thereby providing a display device with good display quality.

Further, by modulating the driving signals based on the video signals of the previous field, a response speed of the pixels can be increased by the modulation. In addition, less memory space is required for the modulation, as compared with modulating the driving signals by referring to the video signals of the previous frame.

For a simpler circuit structure, the method may be adapted so that, in at least one of the step (III) and step (IV), video signals are interpolated for a respective line of a field other than a target field of interpolation in such a manner that the interpolated video signals contain the same information as target field video signals of a frame line adjacent to the interpolated line. As the term is used herein, “target field” refers to the field based on which interpolation is carried out. For example, the target field is the previous field in step (III), and is the current field in step (IV).

With this method, the video signals in the interpolated line of a field other than the target field contain the same information as the video signals in the line of the target field adjacent to the interpolated line. Interpolation between lines can thus be carried out only by storing video signals of one line and by outputting the video signals of one line more than once. As a result, a circuit structure can be simplified.

When two fields make up one frame, the method may be adapted not to interpolate video signals containing the same information but, in at least one of the step (III) and step (IV), video signals are interpolated for a respective line of a field other than a target field of interpolation in such a manner that the interpolated video signals contain the same information as video signals obtained by averaging target field video signals respectively of a pair of frame lines adjacent to the interpolated line.

The method averages the previous and current lines of the target field to generate a line between these lines. This is more advantageous in displaying a smoother image than interpolating video signals containing the same information. Further, interpolation can be carried out with a simpler circuit structure, as compared with referring to other video signals, or video signals of the previous and current lines of the target field without taking an average. As a result, a display device with improved display quality can be provided with a relatively simple circuit structure.

Further, when two fields make up one frame, the method may be adapted so that, in at least one of the step (III) and step (IV), video signals are interpolated for a respective line of a field other than a target field of interpolation in such a manner that the interpolated video signals contain the same information as target field video signals respectively of a pair of frame lines adjacent to the interpolated line, and that video signals for respective pixels of the interpolated line are generated based on video signals for a plurality of pixels in one of the pair of frame lines and based on video signals for a plurality of pixels in the other line of the pair of frame lines.

The method generates a video signal for each pixel of the interpolated line based on video signals for a plurality of pixels in one of the pair of lines of the target field and video signals for a plurality of pixels in the other line of the line pair. This enables respective lines of the target field to be interpolated more smoothly than interpolating video signals containing the same information, or interpolating video signals by taking an average, thereby realizing a display device with improved display quality.

When two fields make up one frame, the method may be adapted so that, in at least one of the step (III) and step (IV), video signals are interpolated in a respective line of a field other than a target field of interpolation based on target field video signals respectively of a pair of frame lines adjacent to the interpolated line and based on video signals in adjacent fields of the target field.

The method interpolates respective lines of the target field by referring to not only the video signals of the target field but also the video signals of a field adjacent to the target field. This enables respective lines of the target field to be interpolated more smoothly, thereby realizing a display device with improved display quality.

Irrespective of how the interpolation is carried out, the method may be adapted so that two fields make up one frame, and the method further includes the step of adjusting strength of modulation in the step (II) by referring to a result of comparison between video signals of the current field and video signals of an earlier of previous two fields.

It should be noted here that, irrespective of how the interpolation is carried out, the foregoing driving method is adapted to drive a group of pixels for a display image of one frame based on the video signals of the current field, despite that the video signals of the previous field are referred to. Thus, while the same grayscale level may be maintained when compared on a frame basis, the video signals of the previous field after interpolation may differ from the video signals of the current field after interpolation.

The difference in the video signals of the previous field and the current field does not cause a problem when the response speed of the pixels is slow. However, when the response speed of the pixels is increased by facilitating the grayscale level transition in the modulation step, flicker may be caused by unwanted two-way driving of the pixels, and it may be recognized by a user of the display device.

To avoid this, the method is adapted to adjust the strength of modulation in the modulation step by referring to the result of comparison between the video signals of an earlier of the previous two fields and the video signals of the current field. By thus adjusting the strength of modulation in the modulation step based on the result of comparison, the amount of grayscale level transition can be reduced when the pixels undergo two-way driving. This prevents flicker, thereby improving display quality of the display device.

The method may be adapted so that, in the step of adjusting strength of modulation, modulation is stopped in the step (II) when the video signals of the current field substantially match the video signals of the earlier of the previous two fields. With this method, the modulation is stopped when the two video signals substantially match, thereby minimizing an amount of grayscale level transition even with the presence of two-way driving. As a result, flicker can be prevented, and display quality of the display device can be improved.

The method may be adapted so that, in the step of adjusting strength of modulation, strength of modulation is gradually reduced from a full strength to zero strength according to a difference between the video signals of the current field and the video signals of the earlier of the previous two fields, if the difference falls in a predetermined range.

With this method, the strength of modulation is gradually reduced according to the difference of video signals between the current field and the earlier of the previous two fields, if the difference falls within a predetermined range. Thus, even when the strength of modulation is reduced, the change in the strength of modulation does not appear on the display, preventing degradation of display quality.

Instead of providing the adjusting step, the method may be adapted so that, in the step (II), the driving signals for the group of pixels are modulated so as to facilitate a grayscale level transition from the previous field to the current field, and that the grayscale level transition in the step (II) is facilitated to such an extent that, when a pixel undergoes a grayscale level transition from the previous field to the current field by repeating a cycle of grayscale level transition between a first grayscale level and a second grayscale level, an integrated value of luminance for the pixel takes an intermediate value between the first grayscale level and the second grayscale level by causing whichever faster of a response speed with the strongest level of facilitation for a first-to-second grayscale level transition and a response speed with the strongest level of facilitation for a second-to-first grayscale level transition to approach whichever slower of the two response speeds.

It should be noted here that the extent to which a grayscale level transition is facilitated is limited by a circuit structure of the driving circuit, a driving method of the pixels, and a range of grayscale levels that can be expressed by video signals. Thus, when a grayscale level transition is facilitated to a full strength, the response speed of the grayscale level transition from the first-to-second grayscale level often does not match the response speed of the second-to-first grayscale level transition. When the difference between the response speeds is large, an average value of luminance for a pixel may fall outside of the range of the first grayscale level and the second grayscale level when the pixel undergoes two-way driving, with the result that the pixel stands out in a group of pixels.

To avoid this, in the foregoing method, the extent to which a grayscale level transition is facilitated is set as above. Thus, even when a pixel is undesirably driven back and forth between the first and second grayscale levels as a result of driving a group of pixels for a display image of one frame based basically on the video signals of the current field even though the video signals of the previous field are referred to, the integrated value of luminance for the pixel falls in the range of the first grayscale level and the second grayscale level.

Despite the fact that a group of pixels of one frame are driven to increase luminance, and that driving signals are modulated by referring to the video signals of the previous field to increase the response speed of the pixels, a pixel does not stand out in the pixels even when it undergoes two-way driving. As a result, display quality of the display device can be improved.

The method may be adapted so that the grayscale level transition in the step (II) is facilitated in such a manner that a grayscale level transition with the slowest response speed with the strongest facilitation determines response speeds of other grayscale level transitions, with the slowest response speed substantially matching the other response speeds.

With this method, a substantially uniform response speed can be attained for all transitions between different grayscale levels, making it possible to prevent the problem caused when response speeds are different between grayscale levels. More specifically, it is possible to prevent a problem that a displayed moving object appears transparent when fast-responding pixels and slow-responding pixels coexist.

As described, the present invention provides a driving device (21-21d) for a display device (1), the driving device including: current-and-previous field video signal generating means (current-and-previous field video signal generating sections 22-22g) for generating video signals (DAT1) for a current field and video signals (DAT0) for a previous field based on an interlace signal for displaying an image of a respective frame from video signals of a plurality of fields; and driving signal generating means (arithmetic circuits 23-23c) for generating driving signals (DAT2) for driving the group of pixels to display the frame image, the driving signals being generated according to the video signals of the current field and being modulated according to the video signals of the previous field, the current-and-previous field video signal generating means including: previous-field interpolating means (field memory 32, arbiter 33, line memory 44) for interpolating respective lines of the previous field so as to generate video signals of one frame for the previous field; and current-field interpolating means (line memory 31, 41) for interpolating respective lines of the current field so as to generate video signals of one frame for the current field, and the driving signal generating means respectively generating the driving signals for the group of pixels, so that the driving signals of the respective pixels are modulated by referring to the video signals of the previous field used to generate the driving signals of the respective pixels.

With this structure, the driving signal generating means generates driving signals according to the outputs of the previous-field interpolating means and the current-field interpolating means. This enables the driving device for a display device to drive a group of pixels for the display device using the foregoing driving method for a display device.

Thus, as with the driving method for a display device, despite the fact that a group of pixels of one frame are driven to increase luminance, and that driving signals are modulated by referring to the video signals of the previous field to increase the response speed of the pixels, modulation error caused by mispairing of compared video signals does not occur. As a result, display quality of the display device can be improved.

Further, with the foregoing structure, modulation is carried out by referring to the video signals of the previous field. Thus, in addition to increasing the response speed of the pixels by modulation, less memory space is required for the modulation, as compared with carrying out modulation by referring to the video signals of the previous frame.

The driving device may be adapted so that the interlace signal produces an image of one frame from images of two fields, that the current-field interpolating means includes a line memory (31, 41) for storing video signals of one line of the current field, and for outputting the video signals of one line twice by doubling a frequency of a dot clock for the interlace signal, and that the previous-field interpolating means includes: a field memory (32) for storing the video signals of respective lines of the current field and holding the stored video signals until a next field; and control means (arbiter 33), by referring to the output of the line memory, for causing the field memory to store the video signals of respective lines of the current field, and for causing the field memory to output the video signals of respective lines of the previous field twice at the frequency of the line memory.

With this structure, the field memory required to output the video data of the previous field also serves as the previous-field interpolating means, and the field memory outputs the video data of one line of the previous field twice as the previous-field video signal. Thus, the number of line memories can be reduced from that required when the previous-field interpolating means and the field memory are separately provided, as in a structure, for example, in which the field memory outputs video signals at the frequency of the interlace signal, and the line memory, provided on a subsequent stage of the field memory, stores the output of the field memory for one line and outputs the video data of one line twice. As a result, the driving device for a display device can be realized with a small circuit scale.

Instead of causing the field memory to operate as the previous-field interpolating means, the driving device may be adapted so that the interlace signal produces an image of one frame from images of two fields, and that the current-and-previous field video signal generating means includes a field memory (42, 42b) for outputting the interlace signal with a delay of one field, and that the current-field interpolating means includes a current-field line memory (41) for storing video signals of one line of the current field, and for outputting the video signals of one line twice by doubling a frequency of a dot clock for the interlace signal, and that the previous-field interpolating means includes a previous-field line memory (44) for storing video signals of one line outputted from the field memory, and for outputting the stored video signals of one line twice at the frequency of the current-field line memory.

Unlike the structure in which the field memory serves as the previous-field interpolating means, the driving device is adapted so that the frequency of the dot clock for the video signals outputted from the field memory is set at the frequency of the dot clock for the interlace signal. This enables the operating frequency of the field memory to be reduced. As a result, the driving device for a display device is relatively easy to design in terms of circuit structure and can readily devise a countermeasure against EMI (Electro-Magnetic Interference).

Further, the driving device may be adapted so that corresponding-field video signal generating means (51, 51c) for storing the video signals of the current field until input of a field having video signals on corresponding positions, and for outputting the stored video signals as corresponding-field video signals (previous-corresponding-field video signal DAT00), and that the driving signal generating means (23b, 23c) compares the corresponding-field video signals with the video signals of the current field, and, based on a result of comparison, varies strength of facilitation of a grayscale level transition from the previous to current field, so as to generate the driving signals.

With this structure, the driving signal generating means compares the corresponding-field video signals and the current-field video signals, and, based on the result of comparison, changes the strength by which the grayscale level transition from the previous to current field is facilitated. Thus, as with the driving method for a display device in which the strength of facilitation of grayscale level transition is adjusted according to the result of comparison, the amount of grayscale level transition can be reduced when the pixels undergo two-way driving. As a result, flicker can be prevented, and display quality of the display device can be improved.

When the interlace signal is for displaying an image of one frame from images of two fields, the driving device may be adapted so that the current-field interpolating means includes a current-field line memory (41) for storing video signals of one line of the current field, and for outputting the stored video signals of one line twice by doubling a frequency of a dot clock for the interlace signal, and that the driving device further includes: a field memory (42b) for storing the video signals of the current field until input of a later of next two fields; control means (arbiter 43b) for causing the field memory to output video signals of one line of the previous field alternately with video signals of one line of a previous-corresponding-field at the frequency of the current-field line memory; and a field line memory (44) for storing the video signals of one line of the previous-corresponding-field outputted from the field memory, and for outputting the stored video signals of one line of the previous-corresponding-field twice at the frequency of the current-field line memory, and that the previous-field interpolating means includes a previous-field line memory for storing the video signals of one line outputted from the field memory, and for outputting the stored video signals of one line twice at the frequency of the current-field line memory, and that the driving signal generating means includes: comparing means (comparing circuit 62) for comparing the video signals of the current field outputted from the current-field interpolating means with the video signals of the previous-corresponding-field with respect to each pixel, and for outputting a result of comparison for each pixel; and adjusting means (modulation amount adjusting circuit 63) for adjusting, based on the result of comparison, strength of modulation for the driving signals of the respective pixels.

With this structure, the field memory of the previous-corresponding-field video signal generating means outputs the video signals of the previous field alternately with the video signals of the previous-corresponding-field, and the previous-field interpolating means of the current-and-previous field video signal generating means generates the previous-field video signals based on the output of the field memory.

In this way, the driving device for a display device can be realized with less memory space, as compared with a structure in which the field memory for storing the previous-field video signals, separately provided from the field memory, is used to generate the previous-field video signals.

As noted above, the field memory outputs video signals of the previous field and video signals of the previous corresponding field. These video signals are interpolated by their respective line memories. Thus, a common field memory is used to store the respective video signals, and the field memory outputs the video signals by doubling the frequency of the dot clock for the interlace signal. Despite this, the driving signal generating means is able to modulate the driving signals by correctly referring to the previous-field video signals, and the comparing means is able to compare video signals of the current field and video signals of the previous-corresponding-field with respect to each pixel.

When the interlace signal is for displaying an image of one frame from images of two fields, the driving device may be adapted not to interpolate video signals for the previous corresponding field outputted from the field memory but may be adapted so that the current-field interpolating means includes a current-field line memory (31) for storing video signals of one line of the current field, and for outputting the stored video data of one line twice by doubling a frequency a dot clock for the interlace signal, and the driving device may further include: a field memory (42b) for storing the video signals of the current field until input of a later of next two fields; and control means (adjusting circuit 43b) for causing the field memory to output the video signals of one line of the previous field alternately with video signals of one line of a previous-corresponding-field at the frequency of the current-field line memory, wherein the previous-field interpolating means includes a previous-field line memory (44) for storing the video signals of one line outputted from the field memory, and for outputting the stored video signals of one line twice at the frequency of the current-field line memory, and wherein the driving signal generating means includes: comparing means (comparing circuit 62c) for comparing, with respect to each pixel, the video signals of the previous-corresponding-field with every other lines of the video signals outputted from the current-field interpolating means, and for outputting a result of comparison for each pixel; a comparison-result line memory (64) for storing the result of comparison for one line, and for outputting the stored result twice at the frequency of the current-field line memory; and adjusting means (modulation amount adjusting circuit 63) for adjusting, based on the pixel-wise output of the comparison-result line memory, strength of modulation for the driving signals of the respective pixels.

With this structure, instead of causing the previous-corresponding-field line memory to interpolate video signals for the previous corresponding field outputted from the field memory, comparison-result line memory interpolates between lines based on the result of comparison. The memory space required to store the result of comparison is usually smaller than that for storing the video data itself. Thus, by interpolating between lines of the comparison result instead of the video signals of the previous corresponding field themselves, less memory space is required in the driving device for a display device, enabling a circuit scale to be reduced.

It should be noted here that the previous corresponding field belongs to the previous frame, and therefore the respective lines of the previous corresponding field occupy the same position as those of the current field. Thus, video signals to be compared will not be mispaired even when video signals are interpolated between lines of the comparison result, thereby enabling the adjusting means to adjust the strength of modulation for the driving signals of the respective pixels without causing any problem.

A program according to the present invention is for causing a computer to carry out the foregoing steps. Thus, by operating the computer with the program, the computer is able to drive a display device according to the foregoing driving method. As a result, as with the driving method for a display device, despite the fact that a group of pixels of one frame are driven to increase luminance, and that driving signals are modulated by referring to the video signals of the previous field to increase the response speed of the pixels, modulation error caused by mispairing of compared video signals does not occur. As a result, display quality of the display device can be improved.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. A method for driving a group of pixels in a display device to display an image of a respective frame based on an interlace signal for displaying an image of a respective frame from video signals of a plurality of fields,
said method comprising the steps of:
(I) generating driving signals based on video signals of a current field, so as to drive the group of pixels for displaying the frame image;
(II) modulating the driving signals for driving the group of pixels, by referring to video signals of a previous field;
(III) interpolating video signals for the previous field before modulating the driving signals, so as to generate video signals of one frame; and
(IV) interpolating video signals for the current field before modulating the driving signals, so as to generate video signals of one frame,
in said step (II), the driving signals being respectively modulated for the group of pixels by referring to video signals of the previous field used to generate the driving signals for the respective pixels.

2. The method as set forth in claim 1, wherein:
in at least one of said step (III) and said step (IV), video signals are interpolated for a respective line of a field other than a target field of interpolation in such a manner that the interpolated video signals contain the same information as target field video signals of a frame line adjacent to the interpolated line.

3. The method as set forth in claim 1, wherein:
two fields make up one frame; and
in at least one of said step (III) and said step (IV), video signals are interpolated for a respective line of a field other than a target field of interpolation in such a manner that the interpolated video signals contain the same information as video signals obtained by averaging target field video signals respectively of a pair of frame lines adjacent to the interpolated line.

4. The method as set forth in claim 1, wherein:
two fields make up one frame; and
in at least one of said step (III) and said step (IV), video signals are interpolated for a respective line of a field other than a target field of interpolation in such a manner that the interpolated video signals contain the same information as target field video signals respectively of a pair of frame lines adjacent to the interpolated line, and that video signals for respective pixels of the interpolated line are generated based on video signals for a plurality of pixels in one of the pair of frame lines and based on video signals for a plurality of pixels in the other line of the pair of frame lines.

5. The method as set forth in claim 1, wherein:
two fields make up one frame; and
in at least one of said step (III) and said step (IV), video signals are interpolated in a respective line of a field other than a target field of interpolation based on target field video signals respectively of a pair of frame lines adjacent to the interpolated line and based on video signals in adjacent fields of the target field.

6. The method as set forth in claim 1, wherein:
two fields make up one frame; and
the method further comprises the step of adjusting strength of modulation in said step (II) by referring to a result of comparison between video signals of the current field and video signals of an earlier of previous two fields.

7. The method as set forth in claim 6, wherein:
in said step of adjusting strength of modulation, modulation is stopped in said step (II) when the video signals of the current field substantially match the video signals of the earlier of the previous two fields.

8. The method as set forth in claim 6, wherein:
in said step of adjusting strength of modulation, strength of modulation is gradually reduced from a full strength to zero strength according to a difference between the video signals of the current field and the video signals of the earlier of the previous two fields, if the difference falls within a predetermined range.

9. The method as set forth in claim 1, wherein:
in said step (II), the driving signals for the group of pixels are modulated so as to facilitate a grayscale level transition from the previous field to the current field; and
the grayscale level transition in said step (II) is facilitated to such an extent that, when a pixel undergoes a grayscale level transition from the previous field to the current field by repeating a cycle of grayscale level transition between a first grayscale level and a second grayscale level, an integrated value of luminance for the pixel takes an intermediate value between the first grayscale level and the second grayscale level by causing whichever faster of a response speed with the strongest level of facilitation for a first-to-second grayscale level transition and a response speed with the strongest level of facilitation for a second-to-first grayscale level transition to approach whichever slower of the two response speeds.

10. The method as set forth in claim 9, wherein:
the grayscale level transition in said step (II) is facilitated in such a manner that a grayscale level transition with the slowest response speed with the strongest facilitation determines response speeds of other grayscale level transitions, with the slowest response speed substantially matching the other response speeds.

11. A driving device for a display device, comprising:
current-and-previous field video signal generating means for generating video signals for a current field and video signals for a previous field based on an interlace signal for displaying an image of a respective frame from video signals of a plurality of fields; and
driving signal generating means for generating driving signals for driving the group of pixels to display the frame image, the driving signals being generated according to the video signals of the current field and being modulated according to the video signals of the previous field,
said current-and-previous field video signal generating means including:
previous-field interpolating means for interpolating respective lines of the previous field so as to generate video signals of one frame for the previous field; and
current-field interpolating means for interpolating respective lines of the current field so as to generate video signals of one frame for the current field, and
said driving signal generating means respectively generating the driving signals for the group of pixels, so that the driving signals of the respective pixels are modulated by referring to the video signals of the previous field used to generate the driving signals of the respective pixels.

12. The driving device as set forth in claim 11,
wherein the interlace signal produces an image of one frame from images of two fields,
wherein the current-field interpolating means includes a line memory for storing video signals of one line of the current field, and for outputting the video signals of one line twice by doubling a frequency of a dot clock for the interlace signal, and
wherein the previous-field interpolating means includes:
a field memory for storing the video signals of respective lines of the current field and holding the stored video signals until a next field; and
control means, by referring to the output of the line memory, for causing the field memory to store the video signals of respective lines of the current field, and for causing the field memory to output the video signals of respective lines of the previous field twice at the frequency of the line memory.

13. The driving device as set forth in claim 11,
wherein the interlace signal produces an image of one frame from images of two fields,
wherein the current-and-previous field video signal generating means includes a field memory for outputting the interlace signal with a delay of one field,
wherein the current-field interpolating means includes a current-field line memory for storing video signals of one line of the current field, and for outputting the video signals of one line twice by doubling a frequency of a dot clock for the interlace signal, and
wherein the previous-field interpolating means includes a previous-field line memory for storing video signals of one line outputted from the field memory, and for outputting the stored video signals of one line twice at the frequency of the current-field line memory.

14. The driving device as set forth in claim 11, further comprising:
corresponding-field video signal generating means for storing the video signals of the current field until input of a field having video signals on corresponding positions, and for outputting the stored video signals as corresponding-field video signals,
wherein the driving signal generating means compares the corresponding-field video signals with the video signals of the current field, and, based on a result of comparison, varies strength of facilitation of a grayscale level transition from the previous to current field, so as to generate the driving signals.

15. The driving device as set forth in claim 11,
wherein the interlace signal produces an image of one frame from images of two fields,
wherein the current-field interpolating means includes a current-field line memory for storing video signals of one line of the current field, and for outputting the stored video signals of one line twice by doubling a frequency of a dot clock for the interlace signal, and
said driving device further comprises:
a field memory for storing the video signals of the current field until input of a later of next two fields;
control means for causing the field memory to output video signals of one line of the previous field alternately with video signals of one line of a previous-corresponding-field at the frequency of the current-field line memory; and
a field line memory for storing the video signals of one line of the previous-corresponding-field outputted from the field memory, and for outputting the stored video signals of one line of the previous-corresponding-field twice at the frequency of the current-field line memory, and
wherein the previous-field interpolating means includes a previous-field line memory for storing the video signals of one line outputted from the field memory, and for outputting the stored video signals of one line twice at the frequency of the current-field line memory, and
wherein the driving signal generating means includes:
comparing means for comparing the video signals of the current field outputted from the current-field interpolating means with the video signals of the previous-corresponding-field with respect to each pixel, and for outputting a result of comparison for each pixel; and
adjusting means for adjusting, based on the result of comparison, strength of modulation for the driving signals of the respective pixels.

16. The driving device as set forth in claim 11,
wherein the interlace signal produces an image of one frame from images of two fields, and
wherein the current-field interpolating means includes a current-field line memory for storing video signals of one line of the current field, and for outputting the stored video data of one line twice by doubling a frequency a dot clock for the interlace signal, and
said driving device further comprises:
a field memory for storing the video signals of the current field until input of a later of next two fields; and
control means for causing the field memory to output the video signals of one line of the previous field alternately with video signals of one line of a previous-corresponding-field at the frequency of the current-field line memory, and
wherein the previous-field interpolating means includes a previous-field line memory for storing the video signals of one line outputted from the field memory, and for outputting the stored video signals of one line twice at the frequency of the current-field line memory, and
wherein the driving signal generating means includes:
comparing means for comparing, with respect to each pixel, the video signals of the previous-corresponding-field with every other lines of the video signals outputted from the current-field interpolating means, and for outputting a result of comparison for each pixel;
a comparison-result line memory for storing the result of comparison for one line, and for outputting the stored result twice at the frequency of the current-field line memory; and
adjusting means for adjusting, based on the pixel-wise output of the comparison-result line memory, strength of modulation for the driving signals of the respective pixels.

17. A program for a computer for driving a group of pixels to display an image of a respective frame based on an interlace signal for displaying an image of a respective frame from video signals of a plurality of fields,
said program causing the computer to carry out the steps of:
(I) generating driving signals based on video signals of a current field, so as to drive the group of pixels for displaying the frame image;
(II) modulating the driving signals for driving the group of pixels, by referring to video signals of a previous field;
(III) interpolating video signals for the previous field before modulating the driving signals, so as to generate video signals of one frame; and
(IV) interpolating video signals for the current field before modulating the driving signals, so as to generate video signals of one frame,
in said step (II), the driving signals being respectively modulated for the group of pixels by referring to the video signals of the previous field used to generate the driving signals of the respective pixels.

18. A recording medium with a program for a computer for driving a group of pixels to display an image of a respective frame based on an interlace signal for displaying an image of a respective frame from video signals of a plurality of fields,
said program causing the computer to carry out the steps of:
(I) generating driving signals based on video signals of a current field, so as to drive the group of pixels for displaying the frame image;
(II) modulating the driving signals for driving the group of pixels, by referring to video signals of a previous field;
(III) interpolating video signals for the previous field before modulating the driving signals, so as to generate video signals of one frame; and
(IV) interpolating video signals for the current field before modulating the driving signals, so as to generate video signals of one frame,
in said step (II), the driving signals being respectively modulated for the group of pixels by referring to the video signals of the previous field used to generate the driving signals of the respective pixels.
